(19) United States
(12) Patent Application Publication
(10) Pub. No.: US 2016/0249766 A1
(43) Pub. Date: Sep. 1, 2016

(54) AUTOMATED BEVERAGE GENERATING SYSTEM AND METHOD OF OPERATING THE SAME

(71) Applicant: Briggo, Inc., Austin, TX (US)

(72) Inventors: Charles F. STUDOR, Austin, TX (US); Stephen A. MILLER, Austin, TX (US); Marwan HASSOUN, Austin, TX (US)

(21) Appl. No.: 15/055,751

(22) Filed: Feb. 29, 2016

Related U.S. Application Data
(60) Provisional application No. 62/126,449, filed on Feb. 28, 2015.

(51) Int. Cl. A47J 31/52; A47J 31/40

(52) U.S. Cl. CPC A47J 31/52; A47J 31/40

(57) ABSTRACT

A method of operating an automated beverage generating system. The method comprising receiving electrical signal(s) representative of an order for a beverage, the beverage having a specified temperature associated therewith and includes a first and a second ingredient. The method further comprises determining an amount of the first ingredient to be used, the first ingredient having a first temperature associated therewith. The method further comprises determining an amount of the second ingredient and determining a second temperature for the second ingredient based on the amount and the first temperature of the first ingredient and the amount of the second ingredient so that the beverage will be at the specified temperature when presented to a user. The method still further comprises generating the beverage using the determined amount of the first ingredient and the determined amount and the second temperature of the second ingredient, and presenting the beverage to a user.

### CROSS REFERENCE TO RELATED APPLICATIONS

This application claims the benefit of U.S. Provisional Application Ser. No. 62/126,449 filed on Feb. 28, 2015, which is hereby incorporated by reference in its entirety.

### TECHNICAL

This disclosure relates generally to systems and methods for generating and dispensing beverages, such as, for example, brewed beverages, and more particularly to automated systems and methods for producing and dispensing brewed beverages.

### BACKGROUND

Known automated beverage generating systems may comprise any number of components to facilitate the ordering of a beverage, the generation or production of the ordered beverage and ultimately the delivery or presentation of the generated beverage to a user (e.g., a customer or another individual). Such systems may include or support, for example, one or more user input devices or interfaces to allow a user to select or order a desired beverage, one or more modules configured to contribute to the generation or production of the desired beverage and one or more delivery mechanisms to deliver the completed beverage to the user.

Such automated beverage generating systems generally provide any number of benefits, for example, reducing (or eliminating) the number of personnel required to generate beverages as compared to, for example, a retail coffee shop, and providing for the production a wider range of beverages that are of a much higher quality than, for example, beverages generated by conventional vending machines. Such known systems are not necessarily without their disadvantages or drawbacks, however.

For example, modules used to perform processes or steps required to generate a beverage may breakdown or their operation may stray from certain desired operating standards. Because the automated beverage generating system may not be staffed with personnel who may be able to fix or service the issue(s) with the module(s) or take other remedial action, the entire system may be rendered inoperable or at least not operable at an acceptable level until the issue with the module(s) has been resolved.

Another possible drawback or disadvantage relates to the meeting of specific parameters of the beverage being generated. For example, it is not uncommon for a user to select or specify a desired temperature for their beverage, or for a beverage recipe to call for the beverage to be served at a particular temperature. Various factors may make meeting the specified temperature challenging. For example, the ambient temperature within the system may cause one or more ingredients to cool as the beverage is being generated or produced, thereby reducing the temperature of the beverage as a whole. Similarly, for beverages that require several ingredients, the temperature of one or more ingredients may cause the temperature of the entire beverage to change. Another factor is the amount of time the generated beverage may sit within the system prior to delivery to the user. More specifically, if a beverage was generated too far ahead of a time at which the user was to retrieve the beverage, the delay between the completion of the production process and the ultimate delivery of the beverage may cause a change in the temperature of the beverage resulting in the temperature at delivery not meeting the specified temperature.

Accordingly, there is a need for an automated beverage generating system and method of operating the same that minimizes and/or eliminates one or more of the above-identified deficiencies.

### SUMMARY

According to one embodiment, there is provided a method of operating an automated beverage generating system. The method comprises receiving one or more electrical signals representative of an order for a beverage, the beverage having a specified temperature associated therewith and includes at least a first and a second ingredient. In an embodiment, the method comprises determining an amount of the first ingredient to be used in generating the beverage, the first ingredient having a temperature associated therewith. The method also comprises determining an amount of the second ingredient to be used in generating the ordered beverage, and determining a temperature to be used for the second ingredient. The temperature determination may be based at least in part on the amount and temperature of the first ingredient and the amount of the second ingredient so that the beverage will be at the specified temperature when presented to, for example, a customer who ordered the beverage. The method further comprises generating the beverage using the determined amount of the first ingredient and the determined amount and the determined temperature of the second ingredient. The method may still further include presenting the generated beverage.

According to another embodiment, there is provided an automated beverage generating system. The system comprises an electronic processor having one or more electrical inputs and one or more electrical outputs, and an electronic memory device electronically coupled to the electronic processor and having instructions stored therein. The electronic processor is configured to access the memory device and execute the instructions stored therein such that the processor is configured to receive one or more electrical signals representative of an order for a beverage, wherein the beverage has a specified temperature associated therewith and includes at least a first and a second ingredient. The processor is further configured to determine an amount of the first ingredient to be used in generating the beverage, the first ingredient having a temperature associated therewith. The processor is still further configured to determine an amount of the second ingredient to be used in generating the ordered beverage, and to determine a temperature to be used for the second ingredient. The temperature determination may be based at least in part on the amount and temperature of the first ingredient and the amount of the second ingredient so that the beverage will be at the specified temperature when the beverage is presented to a user, for example, the customer who ordered the beverage. The processor is further configured to command the generation of the beverage using the determined amount of the first ingredient and the determined amount and the determined temperature of the second ingredient.

According to another embodiment, there is provided a method of operating an automated beverage generating system. The method comprises receiving one or more electrical signals representative of an order for a beverage having a specified temperature associated therewith. The method further comprises dispensing a first ingredient into a container in which at least a portion of the ordered beverage is being generated, and dispensing a second ingredient into the container, the second ingredient having a temperature associated therewith. Prior to dispensing the second ingredient, the method further comprises determining an amount of time that has elapsed since the first ingredient was dispensed, and determining the temperature to be used for the second ingredient based at least in part on the amount of time that has elapsed so that the beverage will be at the specified temperature when the generation of the beverage is complete and the beverage is presented to a user, for example, the customer who ordered the beverage.

According to another embodiment, there is provided an automated beverage generating system. The system comprises an electronic processor having one or more electrical inputs and one or more electrical outputs, and an electronic memory device electronically coupled to the electronic processor and having instructions stored therein. The electronic processor is configured to access the memory device and execute the instructions stored therein such that the processor is configured to receive one or more electrical signals representative of an order for a beverage having a specified temperature associated therewith. The processor is further configured to command the dispensing of a first ingredient into a container in which at least a portion of the ordered beverage is being generated, and to command the dispensing of a second ingredient into the container, the second ingredient having a temperature associated therewith. The processor is yet still further configured to, prior to commanding the dispensing of the second ingredient, determine an amount of time that has elapsed since the first ingredient was dispensed, and determine the temperature to be used for the second ingredient based at least in part on the amount of elapsed time so that the beverage will be at the specified temperature when the generation of the beverage is complete and the beverage is presented to a user, for example, the customer who ordered the beverage.

According to another embodiment, there is provided a method of operating an automated beverage generating system. The method comprises receiving one or more electrical signals representative of an order for a specified beverage. The method further comprises performing a first task required for generating the specified beverage at a first station. The method still further comprises determining whether to perform a second task required for generating the specified beverage at the first station or at a second station at which the second task can be performed. When it is determined that the second task is to be performed at the first station, the method comprises performing the second task at the first station. When it is determined that the second task is to be performed at the second station, the method comprises controlling the movement of a container in which at least a portion of the specified beverage is being generated to the second station, and performing the second task at the second station.

According to another embodiment, there is provided an automated beverage generating system. The system comprises an electronic processor having one or more electrical inputs and one or more electrical outputs, and an electronic memory device electronically coupled to the electronic processor and having instructions stored therein. The electronic processor is configured to access the memory device and execute the instructions stored therein such that the processor is configured to receive one or more electrical signals representative of an order for a specified beverage. The processor is further configured to command or control performance of a first task required for generating the specified beverage at a first station. The processor is still further configured to determine whether to perform a second task required for generating the specified beverage at the first station or at a second station at which the second task can be performed. When it is determined that the second task is to be performed at the first station, the processor is configured to command or control the performance of the second task at the first station. When it is determined that the second task is to be performed at the second station, the processor is configured to command or control the movement of a container in which at least a portion of the specified beverage is being generated to the second station, and to command or control the performance of the second task at the second station.

### DESCRIPTION OF THE DRAWINGS

Preferred embodiments will hereinafter be described in conjunction with the appended drawings, wherein like designations denote like elements, and wherein:

FIG. 1 is a schematic and diagrammatic view of an automated beverage generating system;

FIG. 2 is a diagrammatic view of an illustrative embodiment of a beverage-producing kiosk of an automated beverage generating system, for example, the system illustrated in FIG. 1;

FIG. 3 is a diagrammatic view of an illustrative embodiment of the kiosk illustrated in FIG. 2 that is configured to produce an espresso-based beverage;

FIG. 4 is a perspective view of an illustrative embodiment of a beverage generating station of a beverage-producing kiosk, for example, the kiosk illustrated in FIG. 2;

FIG. 5 is a diagrammatic and schematic view of an interconnection of various components of a beverage-producing kiosk, for example, the kiosk illustrated in FIG.

FIG. 6 is a diagrammatic view of an expressor unit of a beverage-producing kiosk, for example, the kiosk illustrated in FIG. 2;

FIG. 7 is a flow diagram depicting various steps of an illustrative embodiment of a method of operating an automated beverage generating system, for example, the beverage generating system illustrated in FIG. 1;

FIGS. 8 and 9 depict illustrative embodiments of graphical user interfaces (GUIs) that may be used to order beverages from a beverage generating system, for example, the system illustrated in FIG. 1;

FIG. 10 is a flow diagram depicting various steps of another illustrative embodiment of a method of operating an automated beverage generating system, for example, the beverage generating system illustrated in FIG. 1; and

FIG. 11 is a diagrammatic and schematic view of another illustrative embodiment of a beverage generating station of a beverage-producing kiosk, for example, the kiosk illustrated in FIG. 2.

### DETAILED DESCRIPTION OF EMBODIMENTS

The methods and systems described herein may be used to produce and dispense beverages, such as, for example and without limitation, brewed beverages (e.g., hot or cold brewed beverages). For purposes of this disclosure, the phrase “brewed beverages” or “brewed beverage” is intended to mean any consumable beverage that is made through a process in which a liquid and one or more ingredients are combined though one or more of mixing, stirring, boiling, steeping, infusion, frothing, pressurization, and/or fermentation over a prescribed period of time. Examples of brewed beverages include, but are not limited to, coffee, tea, espresso, and beer. It will be appreciated that while the description below is primarily with respect to the production of brewed beverages, the present disclosure is not meant to be so limited. Rather, the methods and systems described herein may also be used to produce other types of prepared beverages, such as, for example, hot chocolate, energy drinks and alcoholic cocktails, to name a few. In any event, the system may be implemented as a single, fully-automated kiosk that, in an embodiment, is configured to communicate with a central host; or as a network of kiosks, each of which is configured to communicate with a central host and one or more other kiosks. For purposes of this disclosure, a fully-automated kiosk is intended to mean a kiosk wherein one or more tasks for generating a beverage are automated or performed automatically (i.e., without human involvement). This may include all of the tasks for generating a beverage and presenting it to a user, or may alternatively include some but less than all of the tasks required for generating and presenting the beverage. In any event, the system may reduce the fixed overhead associated with serving high quality beverages, as well as the capital required to create a point-of-sale (POS) kiosk unit. The system and methods described herein may create a quality beverage that, in at least some embodiments, meets with customer/user-defined specifications, while eliminating (or at least reducing) the need for personnel, such as, for example, expert baristas, and may maximize the intervals between required service by a technician. The systems and method described herein include automated beverage generation apparatus that is/are able to automatically perform one or more of the beverage generation steps/tasks for a given beverage even if human intervention is required to facilitate other steps/tasks of the beverage generation process (e.g., moving a cup/container in which at least a portion of the beverage is being generated, placing a label on a cup, etc.). Additionally, a kiosk is not intended to be limited to any particular size, location or number of tasks/steps of a beverage generation process it performs.

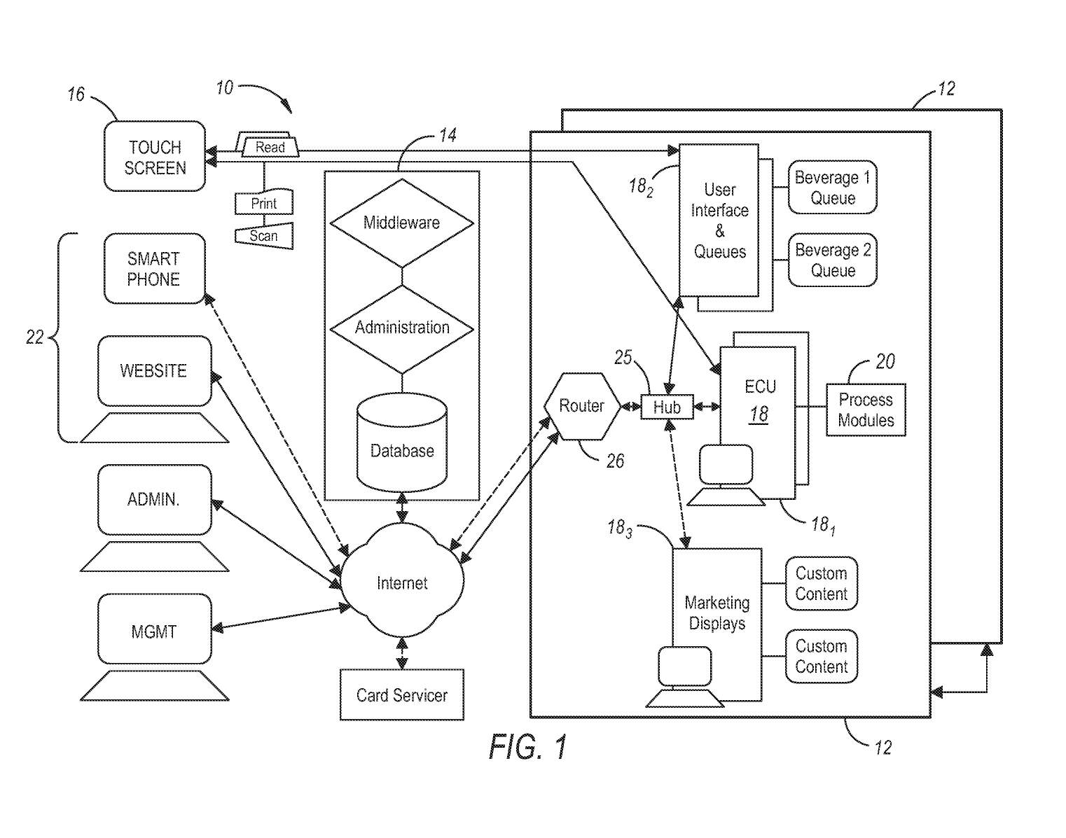

Referring now to the drawings wherein like reference numerals are used to identify identical or similar components in the various views, FIG. 1 illustrates an embodiment of a system 10 for, among other things, preparing and dispensing beverages, such as, for example, brewed beverages. In an embodiment, the system 10 comprises a kiosk 12 (e.g., a standalone or walkup kiosk) and a central host or datacenter 14 configured to communicate with the kiosk 12. In other embodiments, the system 10 may comprise a plurality of kiosks 12, each of which is configured to prepare and dispense beverages and to communicate with the central host 14 and one or more other kiosks 12. Additionally, in other embodiments, the central host 14 can be within a kiosk 12 and alternatively, each of the kiosks 12 may have a duplicate (at least in functionality) of the central host 14 that would allow each kiosk to operate independently and be fully functional and/or control one or more other kiosks as needed.

As described in U.S. Pat. No. 8,515,574 issued on Aug. 20, 2013, U.S. Patent Publication No. 2013/0087050 published on Apr. 11, 2013 and U.S. Patent Publication No. 2014/0277703 published on Sep. 18, 2014, the entire contents of each of which are hereby incorporated by reference, in an embodiment the kiosk 12 comprises a plurality of components that may allow for a fully automated kiosk having the functionality to, in general terms, take ground coffee or beans as an input and to produce a fully lidded brewed beverage as an output. To that end, the kiosk 12 may include, among other components, one or more user interface mechanisms 16, an electronic control unit (ECU 18), and one or more process modules 20. In various embodiments, the kiosk 12 may further comprise a cup handler, a lid dispenser, a completed drink presenter, a presentation area, and various actuators, sensors, and/or other components, some of which are described below.

As shown in the example illustrated in FIG. 1, the kiosk 12 may include one or more user input devices or interfaces 16. A user interface may include any number of devices suitable to display or provide information to a user (e.g., customer, potential customer, administrator, service technician, etc.) and/or to receive information from a user. Accordingly, user interface(s) 16 may comprise, for example, one or more of: a liquid crystal display (LCD); a touch screen LCD (e.g., a touch screen LCD); a cathode ray tube (CRT); a plasma display; a keypad; a keyboard; a computer mouse or roller ball; a joystick; one or more switches or buttons; a graphical user interface (GUI); a text-based interface; or any other display or monitor device. The user interface(s) 16 may further include one or more of: a card reader (e.g., for credit, debit, loyalty, gift, and other like cards); a radio frequency identification (RFID) reader; a coin acceptor; a printer; a loyalty or gift card dispenser; a microphone; and/or a speaker. In an embodiment, one or more user interfaces 16 of the kiosk 12 are disposed at the same location as the kiosk and may be disposed either within the outer housing thereof, or in close proximity thereto, such that it may be accessed by customers. Accordingly, and as will be described more fully below, the user interface(s) 16 provide(s) an interface between the kiosk 12 and a user and may be configured to permit either one-way or two-way communication therebetween.

In an embodiment, in addition to, or instead of the kiosk 12 including one or more user interfaces 16, the system 10 may include one or more user interfaces 22 that are separate and distinct from the kiosk 12, but that are supported by the kiosk(s) 12 of the system 10 and provide a direct or indirect interface between a user and one or more of the kiosks 12 of the system 10. As with the user interface(s) 16 described above, the user interface(s) 22 may be configured to permit either one-way or two-way communication between a user and one or more of the kiosks 12. For example, and as will be described in greater detail below, one or more components of the system 10 (e.g., the ECU 18 of the kiosk 12, the central host 14, etc.) or some other component (e.g., a software application or “app”) may be configured to generate a user interface 22 in the form of a graphical or text-based interface (e.g., having one or more user-selectable or user-inputtable fields or links) that may be displayed, as illustrated in FIG. 1, on a suitable device (e.g., smart phone, tablet, computer, PDA, etc. and allow a user to interact or communicate directly with the kiosk 12, or indirectly through, for example, the central host 14. It will be appreciated that in an embodiment wherein the graphical or text-based user interface is communicated to a suitable user device, such communication may be supported or facilitated by any number of well known communication techniques and protocols, such as, for example, one or more of those described below.

As was briefly described above, in an embodiment, one or more user interfaces 16 of the kiosk 12 and/or one or more user interfaces 22 of the system 10 may be configured to allow for one-way communication from the kiosk 12 or the system 10 to a user. More particularly, the user interface(s) 16, 22 may be configured to allow for the display of messages or other graphics that pertain or may be of interest to a particular user (e.g., customer-specific messages or content), or general messages/information not directed to any one person in particular. In such an embodiment, that or those user interface(s) 16, 22 may not allow for interaction on the part of the user (e.g., to respond to inquiries, place orders through the user interface, etc.). Rather, in such an embodiment, that or those user interface(s) 16, 22 are configured strictly for the display of information or other content.

Conversely, in certain embodiments, one or more user interface(s) 16, 22 may be configured to facilitate two-way communication between the kiosk 12 or the system 10 and a user. More particularly, one or more of user interfaces 16, 22 may comprise an interactive interface that allows a user to interact with, for example, the kiosk 12 and/or the central host 14. For instance, one or more of the user interfaces 16, 22 may be configured to display a message prompting a user to input certain information (e.g., the selection of a function, operation, or customization to be performed; the selection of a beverage to be produced; user identifying information; etc.), and to also provide a means by which such information may be inputted (e.g., user-selectable or user-inputtable fields or links). The input provided by the user may then be communicated to, for example, a component of the kiosk 12 (e.g., the ECU 18) or to the central host 14, which may then take certain action(s) in response to the received input.

In an embodiment, the communication between the user interface(s) 16, 22 and an intended recipient may be direct communication (i.e., electrical signals flow from the user interface directly to the intended recipient (e.g., a component of the kiosk 12, the central host 14, etc.)). In other embodiments, however, the communication may be indirect such that the input received at the user interface may be routed and relayed from the user interface to one or more other components of the kiosk 12 or the system 10, and then to the intended recipient. For example, an input received at a user interface may be routed from the user interface to the central host 14, which may then relay the input to the kiosk 12. Similarly, in another example, the input received at a user interface may be communicated from the user interface to a controller or ECU associated therewith, which may then relay the input to an intended recipient such as, for example, the ECU 18 of the kiosk 12 or the central host 14. In yet another example, the input received at a user interface may be routed through, for example, one or more intermediary components of the kiosk 12, such as, for example, a hub (e.g., the hub 25 in FIG. 1), a router (e.g., the router 26 in FIG. 1), a modem, etc., prior to the input reaching the intended recipient. Accordingly, it will be appreciated that a user input received at a user interface may be communicated to the intended recipient(s) in any number of ways, each of which remains within the spirit and scope of the present disclosure. It will be further appreciated that whether the communication described above is one-way or two-way, such communication may be supported or facilitated by any number of well known communication techniques and protocols, such as, for example, one or more of those described below.

Accordingly, in view of the above, it will be appreciated that the user interface(s) 16, 22 may be configured to serve a number of purposes and to perform a number of functions, all of which remain within the spirit and scope of the present disclosure. It will be further appreciated by those of ordinary skill in the art that the user interface(s) 16 and the user interface(s) 22 may be configured to perform some or all of the same functionality. Accordingly, while certain functionality may described herein as being performed only by or through the user interface(s) 16 or the user interface(s) the present disclosure is not intended to be so limited, but rather in various embodiments, and as appropriate, some or all of the functionality may be performed by either the user interface(s) 16 or the user interface(s) 22.

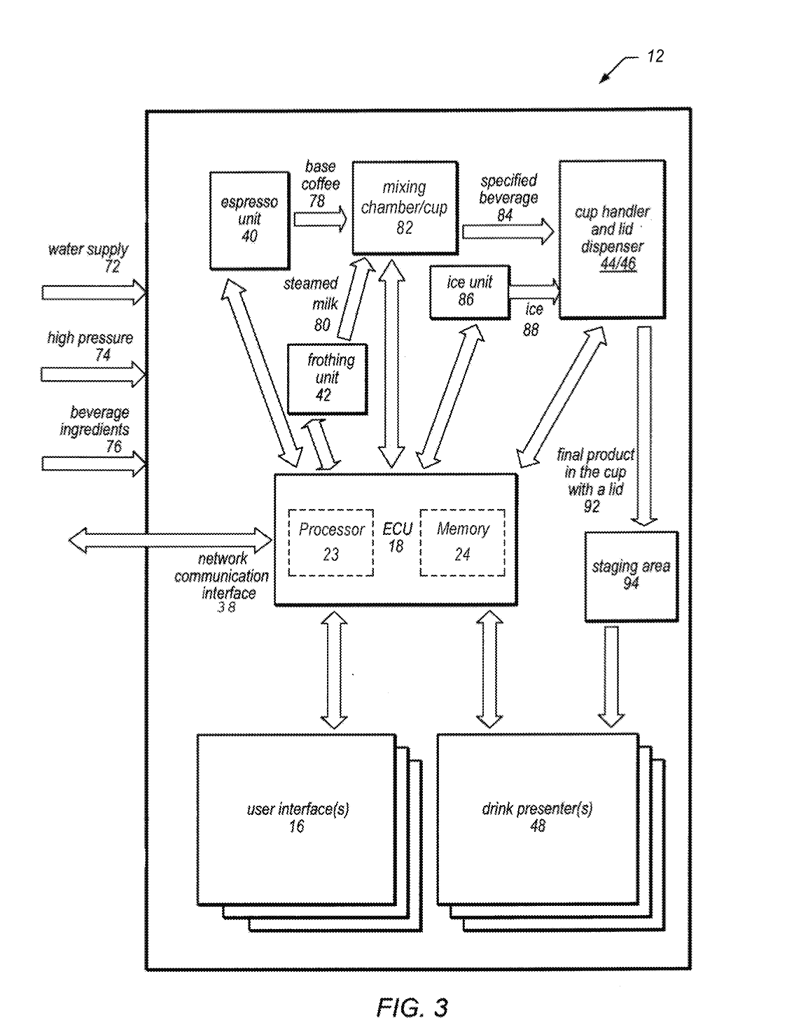

In the embodiment illustrated in FIG. 1, the ECU 18 of the kiosk 12 is disposed within an outer housing or enclosure of the kiosk 12. In other embodiments, the ECU 18 may be alternatively disposed outside of such an enclosure but in close proximity thereto. As shown in FIG. 3, in an embodiment, the ECU 18 comprises one or more electronic processors 23 and one or more electronic memory devices 24 each of which may be part of (i.e., onboard) a processor or at least accessible thereby. In other embodiments, rather than or in addition to the ECU 18 comprising a memory device, the kiosk 12 may include one or more memory devices that are separate and distinct from the ECU 18 but that is/are nonetheless accessible thereby.

The processor(s) 23 of the ECU 18 may include any type of suitable electronic processor (e.g., a programmable microprocessor, a single-core processor, a multi-core processor, a multi-thread processor, a microcontroller, an application specific integrated circuit (ASIC), etc.) that is configured to execute appropriate programming instructions for software, firmware, programs, algorithms, scripts, etc., to perform various functions, such as, for example and without limitation, those described herein (e.g., one or more of the methods described below).

The memory device 24, whether part of the ECU 18 or separate and distinct therefrom, may include any type of suitable electronic memory means known in the art (i.e., one or more of those described elsewhere herein) and may store a variety of data and information. This includes, for example: software, firmware, programs, algorithms, scripts, and other electronic instructions that, for example, are required to perform or cause to be performed one or more of the functions described elsewhere herein (e.g., that are used by ECU 18 to perform various functions described herein); customer-specific data and information; various data structures; operating parameters and characteristics of the kiosk and the components thereof information (e.g., parameters, characteristics, process profiles, etc.) relating to ingredients used in or by the kiosk; beverage recipes; beverage production queues; etc. Alternatively, rather than all of the aforementioned information/data being stored in a single memory device, in an embodiment, multiple suitable memory devices may be provided.

In any event, the aforementioned instructions may be provided as a computer program product, or software, that may include a non-transitory, computer-readable storage medium. This storage medium may have instructions stored thereon, which may be used to program a computer system (or other electronic devices, for example, the ECU 18) to implement the control some or all of the functionality described herein, including one or more steps of the methodology described below. A computer-readable storage medium may include any mechanism for storing information in a form (e.g., software, processing application) readable by a machine (e.g., a computer, processing unit, etc). The computer-readable storage medium may include, but is not limited to, magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical, or other types of medium suitable for storing program instructions. In addition, program instructions may be communicated using optical, acoustical, or other form of propagated signal (e.g., carrier waves, infrared signals, digital signals, or other types of signals or mediums).

As will be described below, the ECU 18 may be electronically connected to other components of the kiosk 12 via I/O devices and suitable connections, such as, for example, a communications bus or a wireless link or optical link, so that they may interact as required. It will be appreciated, however, that the present disclosure is not meant to be limited to any one type of electronic connection, but rather any connection that permits communication between the ECU 18 and other components of the kiosk 12 may be utilized.

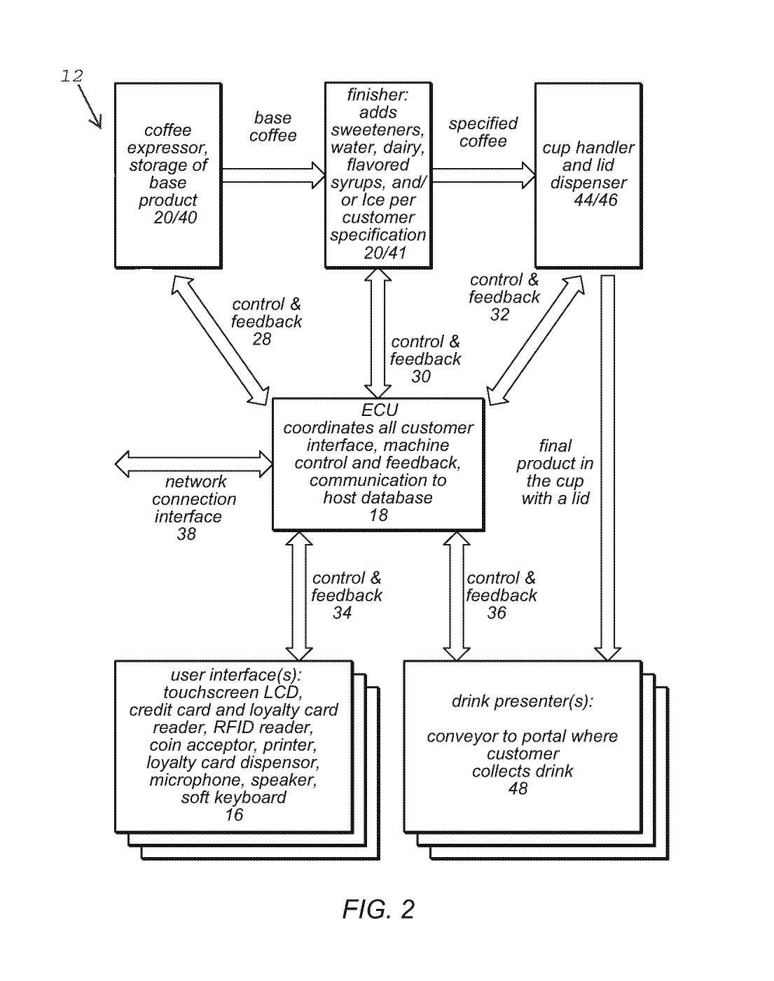

The ECU 18 may be configured to perform, or cause to be performed, some or all of the functionality of the kiosk 12, including, for example, some or all of those functions and features described herein e.g., one or more steps of the various methods described herein described below). For example, and with reference to the illustrated embodiment depicted in FIG. 2, ECU 18 may coordinate all user interfaces 16, machine controls, sensors, and feedback (e.g., control and feedback illustrated at 28, 30, 32, 34, and 36 in FIG. 2), as well as communication to the central host 14 and/or one or more other components or devices of the system 10 (e.g., other kiosks in the system), if applicable. For example, all valves, heaters, pumps, servo motors, flow control mechanisms, and/or other mechanical components of the process modules 20 described below may be controlled by the ECU 18. Accordingly, in an embodiment, the ECU 18 may be configured to receive a request for the production of a beverage and then effect or command the production of the beverage by controlling (directly or indirectly) the operation of one or more of the process modules 20 and/or other components required to produce the beverage or any part thereof. In an embodiment, the ECU 18 may be further configured to exert at least a measure of control over one or more of the user interfaces 16 (and/or user interfaces 22, in certain embodiments) to cause, for example, messages to be displayed thereon notifying a customer, among possibly other things, that the production of the beverage they requested has been completed and that it is ready to be picked-up.

In addition, the ECU 18 may also be configured to interact with the central host 14 for any number of purposes. More particularly, in an embodiment, the ECU 18 provides a gateway through which the central host 14 may monitor or observe the status of any or all components of the kiosk 12, and/or to exert control over one or more components of the kiosk 12. For example, in addition to controlling one or more servos, actuators, valves, process modules, various sensors, mod/or other components of the kiosk 12, the ECU 18 may also be configured to receive and analyze data collected by components of the kiosk 12 (e.g., sensors) to determine, for example, the state of the kiosk 12 or one or more of its constituent components, information relating operational and/or environmental parameters, raw material volumes on hand, age and types of raw materials, current activity, etc. Additionally, and as will be described below, the ECU 18 may be further configured to create and manage a beverage production queue for the kiosk 12 and to share that queue with the central host 14. In either instance, this data/information may be periodically (or on demand) uploaded by the ECU 18 to a local memory device of the kiosk 12 that is part of or accessible by the ECU 18, and/or to the central host 14. The central host 14 may then present the data/information from the kiosk (as well as data/information from other kiosks, in certain embodiments) to, for example, users of the system 10 (e.g., customers, administrators, etc.), and/or store it in a database thereof. Additionally, ECU 18 may be configured to determine that certain operational or environmental conditions exist, and to then provide one or more alerts to the central host 14 and/or another kiosk 12 indicating the existence of such condition(s). The ECU 18 may also be further configured to receive instructions from the central host 14 to perform or cause to be performed certain functionality, and to then carry out those instructions.

As shown in FIG. 2, to facilitate the interaction and communication between the ECU 18 and other components of the system 10 such as the central host 14, the ECU 18 may comprise one or more network or communication interfaces 38 that may include or be electronically connected to, and configured for communication with, other infrastructure of the kiosk 12 (e.g., known components/devices such as, for example, routers, modems, antennas, electrical ports, transceivers, etc.) configured to facilitate and support one or more types of communication networks or techniques/protocols, such as, for example, those described elsewhere below. In any event, the network interface(s) 38 allow(s) for the exchange of data/information between the ECU 18 and one or more other components of the system 10.

It will be appreciated by those having ordinary skill in the art that while the ECU 18 is illustrated as a single component in FIG. 2, in some embodiments, the functionality of the ECU 18 may be performed or caused to be performed by more than one ECU or other like component. For example, in an embodiment, the kiosk 12 may comprise a plurality of ECUs, each one of which is configured to perform or cause to be performed (e.g., command) different functionality. For example, in the illustrative embodiment depicted in FIG. 1, a first ECU (i.e., ECU 18₁) may be configured to control the process modules 20 (i.e., to form a beverage production subsystem, for example), a second ECU (i.e., ECU 18₂) may be configured to control the user interfaces 16 (i.e., to form a user interface subsystem, for example) and a third ECU (i.e., ECU 18₃) may be configured to control various marketing and/or other administrative functions (i.e., to form a marketing/administrative subsystem, for example). In such an embodiment, the various ECUs may be electronically connected to each other to allow for communication therebetween, and each may be configured to also communicate with other components of the system 10, such as, for example the central host 14, through dedicated network interfaces or other components thereof or common network interface(s) of the kiosk 12. In another embodiment, the kiosk 12 may include a number of ECUs configured to control different functionality of the kiosk 12, but also includes a “master” ECU that is configured to manage and control the operation of the individual dedicated ECUs so as to have a coordinated, multi-tiered control scheme for the kiosk 12. In such an embodiment, the master ECU may be the sole ECU that is configured to interface with other components of the system 10, or alternatively, the individual dedicated ECUs may also be configured to interface with one or more other components of the system 10 directly.

While it will be apparent in view of the foregoing that any number of suitable control schemes or arrangements employing one or multiple ECUs or other suitable control/processing devices may be used to carry out the functionality of the kiosk 12 and the various components thereof, in particular, for purposes of illustration and clarity, the description below will be primarily with respect to an embodiment wherein the kiosk 12 includes a single ECU (i.e., the ECU 18) for controlling most, if not all, of the functionality of the kiosk 12 and the components thereof. It will be appreciated, however, that the present disclosure is not meant to be limited to such an embodiment, but rather any number of suitable control schemes and arrangements may be used, and such other schemes and arrangements remain within the spirit and scope of the present disclosure.

As briefly described above, the kiosk 12 may further comprise one or more process modules 20. Each process module 20 is configured to perform one or more chemical or mechanical processes required for producing one or more beverages or types of beverages. In an embodiment, each process module 20 is configured to perform one or more different mechanical and/or chemical processes than that or those performed by the other process modules. Alternatively, two or more process modules 20 may be configured to perform the same mechanical and or chemical process(es) so as to add a measure of redundancy and flexibility to the kiosk 12 in case one such process module fails or is otherwise inoperable, or there is a high demand for the process(es) performed by those process modules 20.

The process modules 20 may take any number of forms. For example, and as illustrated in FIG. 2, one type of process module is an expressor unit 40 that is configured, for example, to brew coffee. Another type of process module is a finisher unit 41 that is configured, for example, to dispense one or more additives required for various beverages (e.g., flavored syrup, dairy, ice, sweeteners, water, etc.). Still another type of process module is a frothing unit 42 (best shown in FIG. 3) that is configured, as described in U.S. Pat. No. 8,991,795 issued Mar. 31, 2015, the entire contents of which are incorporated here by reference, to froth one or more ingredients (e.g., milk) to be used in the production of certain beverages. Accordingly, in an embodiment, the kiosk 12 includes an array of process modules 20 that are configured to perform a variety of beverage production-related processes. Additionally, while certain examples of process modules were provided above, it will be appreciated that the kiosk 12 may include process modules in addition to or in lieu of those described above as the present disclosure is not intended to be limited to any particular type(s) of process modules.

In any event, each process module 20 may comprise one or more components or devices for performing the chemical and/or mechanical processes that the process module 20 is configured to perform. For instance, an expressor unit may comprise a number of components or devices, such as, for example, a grinder unit (configured to grind coffee beans), a tamper unit (configured to form the coffee grounds from the grinder unit into a “puck”) a brew tube (configured to brew coffee using the puck created by the tamper unit). Accordingly, in an embodiment, one or more process modules 20 may include a combination of components or devices, each of which is configured to perform a different function. Alternatively, one or more process modules 20 may be configured to perform only one process, and therefore, may comprise a single component or device (e.g., only one of a grinder unit, tamper unit, brew tube, etc.). Accordingly, embodiments wherein a given process module 20 is configured to perform a single or multiple processes remain within the spirit and scope of the present disclosure.

In an embodiment, the operation of each process module 20 is controlled by the ECU 18. In such an embodiment, each process module 20 is electronically connected to and configured for communication with the ECU 18. It will be appreciated as described above, however, that in other embodiments, one or more process modules or one or more constituent components thereof, may be alternatively controlled by dedicated ECUs that may be part of that process module or component but that is under the control of the ECU 18, or by other ECUs of the kiosk 12 or the system 10, such as, for example, by the central host 14.

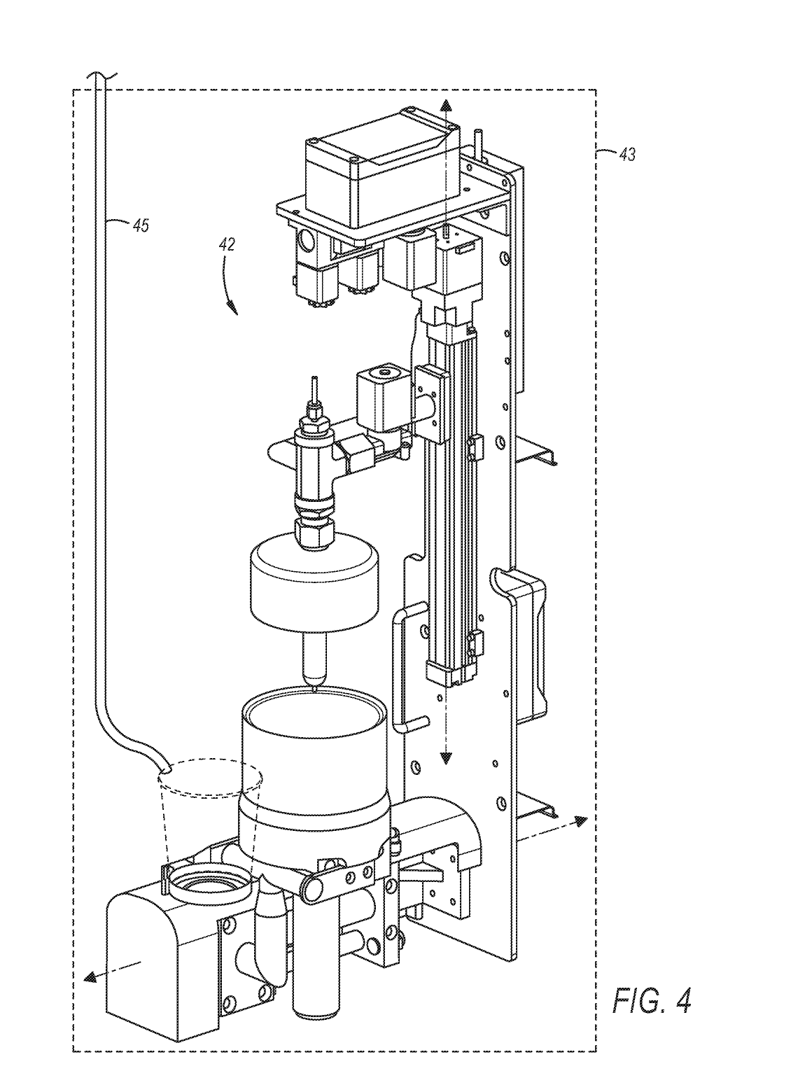

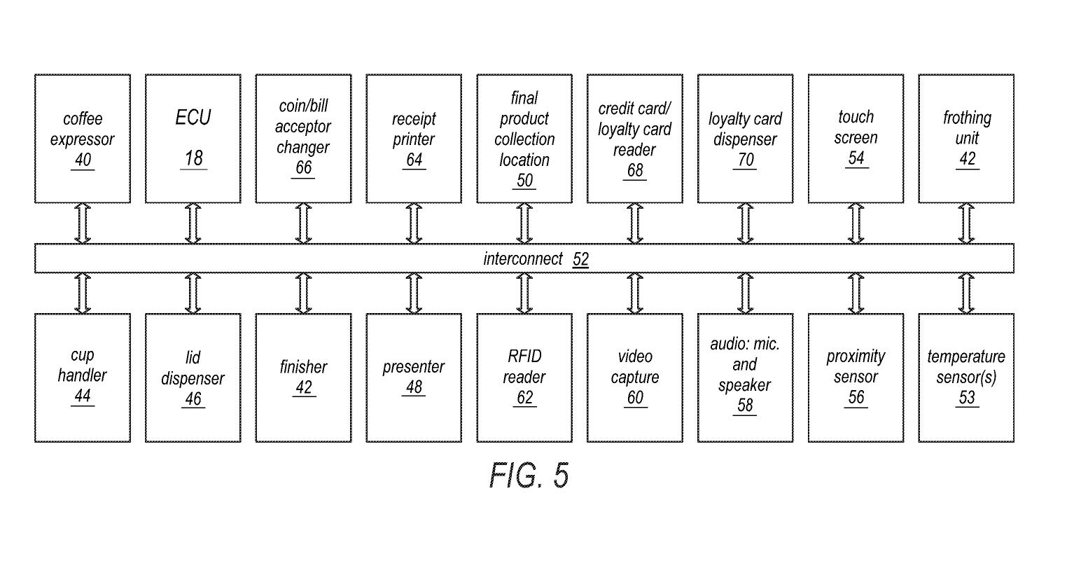

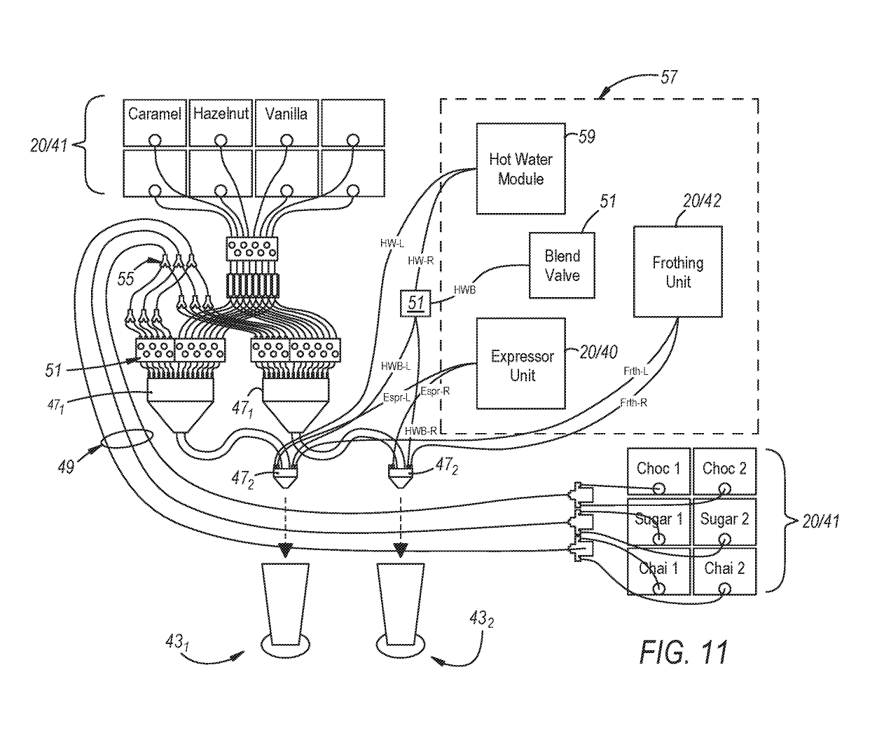

In addition to the kiosk 12 including one or more process modules, in an embodiment, the kiosk 12 may include one or more beverage production or generation stations (e.g., super-automatic machines) at which one or more (and, in certain embodiments, all or at least two or more) of the processes or tasks required for generating a particular beverage may be performed (e.g., two or more ingredients for generating or producing a beverage may be dispensed at a given station without having to have move the cup/container into which the ingredients are dispensed). FIGS. 4 and 11 each depict illustrative embodiments of beverage production stations 43. In an embodiment, each station 43 may include a dedicated ECU or share an ECU with another station 43. In either instance, the ECU may be electrically connected to and configured for communication with the ECU 18 of the kiosk 12. In an embodiment, this electrical connection may be through one or more interconnects of the kiosk 12 (e.g., interconnect 52 shown in FIG. 5), while in other embodiments, other wired or wireless connections may be utilized. The ECU may have a similar construction and operation as that described above with respect to ECU 18, and thus, that description is incorporated here by reference. For a given station having an ECU, the ECU may be configured to receive instructions or commands from the ECU 18 and to then control one or more components of the station 43 to carry out that/those commands. Whether or not a particular station has an ECU or rather is controlled directly by the ECU 18, the stations 43 may take a number of forms and/or have a number of different constructions.

For example, the kiosk may include one or more stations that are each comprised of two or more sub-modules which may, in turn, comprise two or more process modules 20. By way of illustration, a station may include one or more expressor units 40, one or more finisher units 41 and/or one or more frothing units 42. Accordingly, when a cup or container is located at such a station, ingredients dispensed by those process modules may be dispensed into the cup/container and/or other tasks performed by those process modules may be performed without having to move the cup/container to another location.

The kiosk may additionally or alternatively include one or more stations comprised of one or more process modules 20 and one or more apparatus or mechanisms (e.g., tubes) that couple the output(s) of one or more process modules 20 or other components of the kiosk 12 that are located apart from the station (e.g., process module(s) of other stations 43) to the station. For example, as shown in FIG. 4, the station 43 may include a frothing unit 42 and a tube 45 coupled via a valve (not shown) to the output of an expressor unit that is part of a different station or not part of any particular station. Accordingly, when a cup or container is located at such a station, ingredients dispensed by expressor unit remote from the station may be dispensed into the cup/container and tasks performed by the process modules of the station (e.g., frothing) may be performed without having to move the cup/container to another location.

The kiosk may additionally or alternatively include one or more stations that do not actually comprise any process modules, but rather include one or more apparatus or mechanisms that couple the output(s) of one or more process modules 20 or other components of the kiosk 12 located remotely from the station to the station. For example, FIG. 11 depicts two stations 43₁ and 43₂. Neither of these stations actually includes a process module, but rather both stations include mechanisms, for example, funnels (e.g., funnels 47₁, 47₂), fluid pathways 49 (e.g., tubes), etc.) that couple the station to various process modules 20 and/or other components of the kiosk 12. More particularly, in this particular embodiment, the stations 43₁, 43₂ are both fluidly coupled via, for example, fluid pathways 49, various valves 51, and/or splitters 55 to a multi-process module 57 (e.g., super-automatic machine) that comprises a plurality of process modules 20 (e.g., an expressor unit 40, a frothing unit 42, a hot water module 59, etc.), and one or more other process modules 20 (e.g., one or more finisher units 41 for dispensing additives). Accordingly, when a cup or container is located at such a station, ingredients dispensed by the process modules and/or other kiosk components may all be dispensed into the cup/container without having to move the cup/container to another location, e.g., the location of that or those process modules/components.

An arrangement wherein a station includes mechanisms fluidly coupled to output(s) of one or more components or modules located elsewhere may serve a number of purposes. For one, the arrangement may provide redundancy such that if a process module of the station is inoperable, but the station also includes an output of that same type of process module that is located elsewhere, the ingredient supplied by that module can still be dispensed/supplied by routing the ingredient to the station at which the cup/container is located. As a result, the beverage can still be produced and can be done without having to move the container/cup within the kiosk 12. Another purpose that may be served by this arrangement is that it allows for the sharing of resources amongst stations 43. More specifically, instead of including a particular component or process module (e.g., finisher unit, expressor unit, etc.) in each station, two or more stations may share a single component or module with one or more of those stations including an apparatus (e.g., tube, valve, etc.) that couples the output of the component/module to the station(s).

Similar to the above, the kiosk may additionally or alternatively comprise a plurality of apparatus or mechanisms (e.g., tubes) that couple the outputs of two or more process modules 20 or other components of the kiosk 12 that are not part of the station but rather are located elsewhere (e.g., process module(s) of other stations). For example, in an embodiment, a given station may include an apparatus (e.g., tube) coupled via a valve to the output of an expressor unit of a different station or that is not part of any particular station, and a tube coupled via a valve to the output of a finisher unit of a different station or that is not part of any particular station. As with the embodiment described above, such an arrangement allows for the sharing of resources amongst stations.

In view of the foregoing, it will be appreciated that any number of arrangements may be used for a beverage production station of the kiosk 12, and thus, the present disclosure is not intended to be limited to any particular arrangement(s). For example, a single station may include two or more locations (e.g., load cells) where additional containers can be placed and serviced by the various modules (see, for example, FIG. 11) in accordance with the description above.

Turning back to FIG. 2, in an embodiment, the kiosk 12 may further comprise additional components such as, for example, a cup handler 44 and a lid dispenser 46. In one embodiment, these two components may be combined into a single apparatus, while in other embodiments, they may be separate and distinct from each other. In an embodiment, the cup handler 44 is configured to handle or control a cup or other container into which a beverage being produced by the kiosk 12 is ultimately dispensed or in which a beverage a beverage being produced is actually generated. The cup handler 44 may comprise one or more actuators (e.g., XYZ actuators) configured to move or manipulate the position of the cup among various locations within the kiosk 12 during the production of the beverage. In various embodiments, these locations may include, for example: a location where empty cups are stored; a location where the beverage is dispensed into the cup (e.g., a location where a mixing chamber is disposed); locations corresponding to various process modules 20 and/or stations 43 at which different ingredients or components of the beverage may be generated and/or added or dispensed into the cup; locations where partially completed and/or completed beverages are temporarily stored; a location corresponding to the lid dispenser 46; and a location where a beverage presenter component of the kiosk 12 is disposed, to cite a few examples. In an embodiment, the operation of the cup handler 44 is controlled by the ECU 18 of the kiosk 12; though in other embodiments, the cup handler may be controlled by another suitable component.

In an embodiment wherein kiosk 12 includes a lid dispenser, the lid dispenser 46 is configured to dispense lids for placement on cups containing completed or partially completed beverages. As with the cup handler 44, the lid dispenser 46 may comprise one or more actuators (e.g., XYZ actuators) configured to acquire a lid and to place it on the top of a cup/container. Accordingly, in an embodiment, when it is determined that a lid should be placed on a particular cup, the lid dispenser 46 is configured to acquire a lid from a lid storage area in the kiosk 12 and place the lid onto the cup. As with the cup handler 44 the operation of the lid dispenser 46 may be controlled by the ECU 18 or another suitable component of the kiosk 12.

With continued reference to FIG. 2, the kiosk 12 may further comprise one or more beverage presenters 48. The beverage presenter(s) 48 serve to transfer a completed beverage to an area at which customers/users may retrieve the beverage(s) they ordered. In an embodiment, the beverage presenter 48 may include, for example, a conveyor or carrousel upon which the cup handler 44 places a completed beverage and that moves or delivers the beverage to, for example, a customer-accessible presentation or final product collection area 50 (diagrammatically illustrated in FIG. 5) where the beverage may be retrieved by a user/customer. The presentation area may comprise, for example, an area behind a door or window that is accessible upon the door or window opening. More particularly when a beverage is ready for retrieval by the appropriate user, it is placed into the presentation area. When the kiosk 12 recognizes that the user corresponding to the beverage has arrived or is in vicinity of the kiosk 12 (e.g., through an input to a user interface of the kiosk 12, for example), the door or window to the presentation area may be opened so that the customer/user may access the presentation area and retrieve his/her beverage. In various embodiments, the kiosk 12 may include one or more presentation areas that may be utilized to present beverages ordered in different ways (e.g., one presentation area for beverages ordered directly at the kiosk 12 for immediate delivery, and another presentation for pre-ordered beverages that are ordered in advance of a desired pick-up time). As with other components described above, in an embodiment, the operation of the presenter 48 and/or presentation or final product collection area may be controlled by the ECU 18.

In view of the foregoing, it will be apparent that some or all of the components of the kiosk 12 are interconnected to allow for communication and exchange of information therebetween. To that end, FIG. 5 illustrates various interconnected components of an embodiment of the kiosk 12. In this example, all of the illustrated components are connected to a central interconnect 52 (e.g., a communication bus), or alternatively, one or more components may be electronically connected (e.g., by one or more wires or cables or wirelessly) to one or more other components. In the illustrated embodiment, it is through the interconnect 52 that the ECU 18 may receive feedback and other inputs from components of the kiosk 12 (e.g., the process modules 20, the cup handler 44, the lid dispenser 46, the presenter 48, various sensors (e.g., temperature sensors), etc.) and may issue commands (e.g., in the form of machine instructions or signal values) to those components. In various embodiments, one or more of the user interfaces 16, such as, for example, a touch screen 54, a proximity sensor 56, an audio interface 58 (including a microphone and/or speaker), a video capture device 60, an RFID reader 62, a receipt printer 64, a coin/bill acceptor/changer 66, a credit card/loyalty card reader 68, and/or a loyalty card dispenser 70, may provide a customer interface and/or maintenance interface, as controlled by the ECU 18. While only certain components of the kiosk 12 are illustrated in FIG. 5, in other embodiments that remain within the spirit and scope of the present disclosure, additional components, such as, for example, motion detectors or sensors and/or temperature sensors may also be included; or fewer than all of the specifically identified and illustrated components may be included. Accordingly, the present disclosure is not intended to be limited the kiosk 12 having any particular construction or composition, or to two or more different kiosks having the same construction or composition.

In various embodiments, and as described in U.S. Pat. No. 8,515,574, the entire contents of which were incorporated herein by reference above, the kiosk 12 may comprise one or more components that is/are configured to sense or otherwise acquire various environmental parameters (e.g., ambient temperature within the housing/enclosure of the kiosk) or parameters of ingredients (e.g., temperature of the ingredients) that are used in the kiosk 12. For example, in certain embodiments, the kiosk 12 may include one or more temperature sensors 53 (shown diagrammatically in FIG. 5) disposed at one or more locations within the enclosure of the kiosk to measure or detect the temperature at that/those location(s). In an embodiment, one or more of these locations may be locations where tasks for generating beverages are performed, areas where partially completed beverages may be temporarily stored during the production process (e.g., between tasks) and/or where completed beverages may be stored prior to delivery or presentation to the corresponding user. The sensor(s) 53, which may comprise any suitable temperature sensor known in the art, may be electrically connected to one or more components of the kiosk 12, for example, ECU 18, via a wired connection (e.g., interconnect 52 or by dedicated wire(s)) or wirelessly.

In certain embodiments, containers or packaging in which ingredients, for example, coffee beans or additives are stored, may have a bar code or an RFID tag associated therewith that when read may allow for the ECU 18 to acquire various parameters relating to the beans or additives. For example, the ECU 18 may be configured to look up an identifier received from the RFID tag or encoded by the bar code in a database or some other data structure to acquire various parameters of the corresponding ingredients. Alternatively, the parameters may be received by the ECU 18 directly from the RFID tag, or the parameters may be encoded by the bar code that may be acquired when the bar code is read (as opposed to encoding an identifier that must then be used to acquire the parameters). Accordingly, in an embodiment, the kiosk 12 may further comprise an RFID reader, bar code scanner, etc., electronically connected to ECU 18 that may be used by ECU 18 to acquire various parameters of the ingredients associated with the RFID tag or bar code.

In addition or alternatively, various sensors may be used to sense one or more parameters or aspects of certain ingredients, which may allow the ECU 18 to use these parameters in the control of one or more process modules. For example, the kiosk 12 may include a sensor that is configured to measure the carbon dioxide content of coffee beans in the kiosk, and/or to sense the color or other parameter of the coffee beans. Similarly, the kiosk 12 may include one or more temperature sensors to measure the temperature of ingredients stored in the kiosk 12. In any event, the information obtained by or using such sensors may be provided to the ECU 18.

Again, it will be appreciated that while certain components of the kiosk 12 have been specifically identified and described above, the kiosk 12 may include additional components, such as, for example, those that are described herein below. Conversely, it will be further appreciated that in certain embodiments, one or more of those components specifically identified above may not be included in the kiosk 12. Accordingly, the present disclosure is not meant to be limited to any one arrangement of the kiosk 12.

In the illustrative embodiment shown in FIG. 1, the system 10 further includes a central host 14. As described above, such a central host 14 may be part of one of the kiosks 12 and as such, may alternatively be combined with the ECU 18 of that particular kiosk. As will be appreciated by those having ordinary skill in the art, the central host 14 may be implemented with a combination of hardware, software, and/or middleware, and in an embodiment, utilizes a cloud computing architecture. In an embodiment, the central host 14 comprises a host server including one or more databases. The central host 14 may include one or more network or communication interfaces that may include or be electronically connected to, and configured for communication with, certain communication-supporting infrastructure (e.g., one or more known components/devices, such as, for example, routers, modems, antennas, electrical ports, transceivers, etc.) and be configured to communicate with various components of the system 10, including, for example, the kiosk 12 and software applications (commonly known as “apps”) executed on various types of user devices (e.g., computers, smart phones, tablets, etc.), via a public or private network (e.g., the internet) or using other suitable communication techniques or protocols, such as, for example, those described below. In an embodiment, the central host 14 is located remotely from the kiosk 12 (e.g., anywhere from a few feet to any number of miles from the kiosk 12). Alternatively, the central host 14 may be disposed within the housing of one of the kiosks of the system 10, and therefore, may form part of that particular kiosk.

The central host 14 may be configured to perform or cause (e.g., command) to be performed any number of functions and to serve any number of purposes, including, for example and without limitation, those described below. For example, the central host 14 may store and in certain instances manage a variety of information, such as, for example, customer-specific information and/or data and process or operational-related information for one or more of kiosks 12 (e.g., beverage recipes, beverage production queues, empirically-derived profiles to be used in beverage production, component performance information, etc.). As was briefly described above, the central host 14 may be further configured to monitor and manage the operation of one or more kiosks 12 and/or to provide other functionality for efficiently operating one or more kiosks 12.

As was also described above, the central host 14 may be further configured to send requests to one or more kiosks 12 to acquire various operational information from the kiosks (e.g., information relating to inventory, sales information, performance data, environmental information, customer-specific information, etc.), to receive responses containing the requested information, and to then store the requested information in one or more databases thereof, for example. The central host 14 may be further configured to respond to requests or inquiries from the kiosk(s) 12. For instance, a kiosk may send a request to the central host 14 for updates to operational information stored locally at the kiosk 12, and the central host 14 may respond with the requested information. Additionally, in an embodiment, both the central host 14 and the kiosk(s) 12 may be configured to send inquiries to the other (and to receive and respond to inquiries sent by the other, as appropriate) to determine whether or not it and/or the other component are functioning properly, and/or whether there is a problem with the communication link or network over which they communicate.

In addition to the above, the central host 14 may be further configured to send instructions to a kiosk, and the ECU 18 thereof, in particular, instructing it to perform certain tasks, such as, for example, to commence production of a given beverage, to shut down operation of one or more components, and/or to display certain messages or content on a user interface thereof, to name but a few. Accordingly, it will be appreciated that in various embodiments, the central host 14 may be configured to exert a measure of control over some or all of the features and functionality of the kiosk(s) 12 of the system 10.

As was briefly described above, the central host 14 may also serve as an interface to the system 10, and the kiosk(s) 12 thereof, in particular, for customers wishing to place beverage orders remotely from the kiosk(s) 12 (e.g., via an internet web browser, smart phone application, etc.). Accordingly, in an embodiment, the central host 14 may be configured to receive requests to produce one or more beverages placed through, for example, GUIs or text-based interfaces displayed on various customer devices. For example, the central host 14 may be configured to generate or interface with GUIs or text-based interfaces having user-selectable or user-inputtable fields or links that allow for the ordering and, in certain embodiments, customization of various beverages. These orders may then be communicated from the central host 14 to one of kiosk(s) 12, and, in certain embodiments, the ECU 18 thereof in particular.

In an embodiment wherein system 10 comprises a plurality of kiosks 12, the central host 14 may be further configured to determine which kiosk is best equipped produce the customer's requested beverage. This determination may be based on, for example, the ability of a kiosk to produce the requested beverage (e.g., in view of the availability of ingredients for the specified beverage, the operation state of the kiosk, etc.), the location of the customer relative to one or more kiosks, and/or other parameters or factors, such as, for example, current traffic conditions that may be acquired or obtained by central host 14. In such an embodiment, the central host 14 may be further configured to either advise a customer which kiosk to go to, to suggest a particular kiosk or to present the customer with a number of options from which the customer may pick.

It will be appreciated that while certain functions performed or served by the central host 14 have been specifically identified above, the present disclosure is not intended to be limited to the control host being configured to perform or serve only those functions. Rather, it will be appreciated by those having ordinary skill in the art that the central host 14 may be configured to perform any number of additional functions, for example, those described elsewhere herein, or to perform less than all of those functions described herein. Accordingly, it will be appreciated that central hosts configured to perform more or less functions than those described herein remain within the spirit and scope of the present disclosure.

As briefly described above, and as will be described in greater detail below, in an embodiment, the system 10 may comprise two or more kiosks 12 that are configured to communicate both with the central host 14 and each other. Accordingly, in an embodiment, the system 10 comprises a plurality of distributed kiosks 12 networked together to generally allow for, among other things, communication and exchange information amongst one another, as well as between the kiosks 12 and the central host 14. In such an embodiment, each kiosk 12 may be configured both structurally and operationally in the same manner as that described above and below, or one or more of the kiosks may vary in structure and/or operation from one or more of the other kiosks (e.g., one kiosk may have different process modules or other components than another kiosk, one kiosk may be configured to generate different beverages (or more or less types of beverages) as compared to another kiosk, etc.).

For example, in embodiment, the system 10 may include a main or primary kiosk 12 and a group of two or more standalone kiosks 12 in the form of super-automatic machines that have pared-down functionality as compared to the primary kiosk. The primary kiosk 12 may be configured to receive an order for a beverage and to determine where to produce the beverage—i.e., either at the primary kiosk or at one of the other kiosks. In an instance wherein it is determined that the beverage is to be generated or produced at a kiosk other than the primary kiosk (e.g., at one of the super-automatic machines), the primary kiosk 12 (e.g., the ECU 18 thereof) may communicate the order and other relevant information relating thereto (e.g., recipe, timing requirements, etc.) to that machine and command or instruct the machine to generate the beverage. This arrangement or architecture of the system 10 provides for the ability to distribute the load of the system 10 and easily provide additional resources and beverage making capacity to the system 10.

In an embodiment wherein the system 10 comprises multiple kiosks 12 configured to communicate and exchange information with both the central host 14 and each other, this communication and exchange of information may be facilitated across a network through one or more network or communication interfaces of the individual components (such as, for example, the network interfaces 38 of the kiosks 12 that may include or be electronically connected to and configured for communication with certain communication-supporting infrastructure, such as, for example, one or more known components/devices (e.g., routers, modems, antennas, electrical ports, transceivers, etc.)).

More particularly, the network interfaces of the individual components may support communication via one or more wired or wireless networks, such as, for example, a suitable Ethernet network; via radio and telecommunications/telephony networks, such as, for example and without limitation, cellular networks, analog voice networks, or digital fiber communications networks; via storage area networks such as Fibre Channel SANs; or via any other suitable type of network and/or protocol (e.g., local area networks (LANs); wireless local area networks (WLANs); broadband wireless access (BWA) networks; personal Area Networks (PANs) such as, for example, Bluetooth; etc.). The network or communication interfaces of the various components may use standard communications technologies and protocols, and may utilize links using technologies such as, for example, Ethernet, IEEE 802.11, integrated services digital network (ISDN), digital subscriber line (DSL), and asynchronous transfer mode (ATM), as well as other known communications technologies. Similarly, the networking protocols used on a network to which kiosks 12 and host server 14 are interconnected may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. Further, the data exchanged over such a network by the network interfaces of the various components may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as, for example, the secure sockets layer (SSL), Secure HTTP and/or virtual private networks (VPNs), the international data encryption standard (DES or IDEA), triple DES, Blowfish, RC2, RC4, R5, RC6, as well as other known data encryption standards and protocols.

In other embodiments, custom and/or dedicated data communications, representation, and encryption technologies and/or protocols may be used instead of, or in addition to, the particular ones described above. Further, it will be appreciated that in an embodiment, the central host 14 and the kiosks 12 may each be configured to communicate with each other using more than one communication technique or protocol as a fail-safe so as to provide redundancy and flexibility in the event a given technique or protocol is rendered unusable for any reason, or different components communicate using different protocols or techniques.

In an embodiment wherein multiple kiosks 12 are networked together, the distance from one kiosk to another may range from a matter of feet (e.g., within a single building), to an unlimited number of miles (e.g., distributed globally). Accordingly, it will be appreciated that the particular communication techniques and protocols used may depend in large part on the relative distance between the central host 14 and the kiosks and/or between the individual kiosks 12, as well as on the availability of certain infrastructure required for the various techniques/protocols (e.g., cellular reception, existence of PSTN lines, etc). Additional functionality and features provided by a network comprising a plurality of kiosks 12 and the central host 14 will be described below.

In addition to the structural components of the system 10—and the kiosk(s) 12 and the central host 14, in particular—in an embodiment, the system 10 is further configured to support a variety of functions and features in addition to those already described above. As will be described in greater detail below, this additional functionality may be performed or executed by one or a combination of the components of the system 10, individual kiosks 12, and/or the central host 14 described above, or one or more additional components not specifically described above either alone or in conjunction with one or more of the above-described components. Several of these various functions and features will now be described.

### Producing Beverages

It will be appreciated in view of the above that the system 10 and the methods described herein may generally allow for the kiosk 12 to receive an order for a beverage and to automatically generate or produce that beverage. More particularly, in response to receiving a request for the production of a beverage (i.e., an order), which may take the form of one or more electrical signals representative of an order for the beverage, the kiosk 12, and the ECU 18 thereof, in particular, may be configured to control the production of the beverage in accordance with a recipe and, in at least certain embodiments, one or more process profiles that are used to optimize the production process and the quality of the end product such that the end product meets with the customer/user's specifications and expectations. In an embodiment, the ECU 18 may acquire the recipe for the beverage and, if applicable, the process profiles to be used in the production of the beverage, from a database that may be stored locally at the kiosk 12 (e.g., in or on a memory that is part of or accessible by the ECU 18), and/or remotely at, for example, the central host 14. Alternatively, at least a portion of the recipe and/or customer/user specifications may be obtained from the order itself (i.e., from the received electrical signal(s) as opposed to a database). As described above, the kiosk 12 may include a variety of process modules 20 each of which is configured to perform one or more chemical or mechanical processes that contribute to the production of beverages. Accordingly, in an embodiment, the ECU 18 is configured to control the operation of one or more process modules 20 to generate or produce a given beverage and to then effect or cause the presentation of the beverage to the corresponding customer/user.

With reference to FIG. 3, a brief and general description of an illustrative embodiment of a kiosk 12 that is configured to produce, for example, an espresso-based beverage will be provided to better illustrate the operation of the kiosk and the various components thereof. In this embodiment, one or more external inputs to the beverage production process may be received by one or more process modules of the kiosk 12. These inputs may include, for example, water 72 (e.g., through a water supply), high-pressure gas 74 and beverage ingredients 76 (e.g., coffee grounds, additives, etc.). In other embodiments, one or more of these inputs may be sourced from within the kiosk 12 (e.g., from an internal water tank, internal gas tank and/or internal ingredient storage tanks/containers, respectively). In the illustrated example, the kiosk 12 comprises a number of process modules, including one or more expressor units 40, which, in this embodiment, takes the form of an espresso unit (i.e., “espresso unit 40”). Espresso unit 40 is configured to produce a coffee base 78. The kiosk 12 further comprises another process module in the form of a frothing unit 42. Frothing unit 42 is configured to heat and/or froth milk and to provide it as steamed milk 80. In this embodiment, the kiosk 12 further comprises a mixing chamber 82 in which the base coffee 78, the steamed milk 80 and/or other beverage ingredients 76 (e.g., flavors, flavored syrups, sweeteners, etc.) may be combined to produce a beverage 84. In another embodiment, rather than dispensing ingredients or components of the beverage into a mixing chamber and then transferring the contents thereof to a cup that is then presented to the customer/user, the ingredients may be dispensed directly into the cup that is ultimately presented to the customer. In such an embodiment, the cup may remain stationary as the ingredients are dispensed therein or may be moved within the kiosk 12 between various locations at which ingredients are dispensed or other processes are performed e.g., between various process modules 20, production stations 43, etc., depending on the particular implementation). In any event, in the example illustrated in FIG. 3, if beverage 84 is an iced drink, a process module in the form of an ice unit 86 may provide ice 88 that may be dispensed into a cup along with the specified beverage 84.

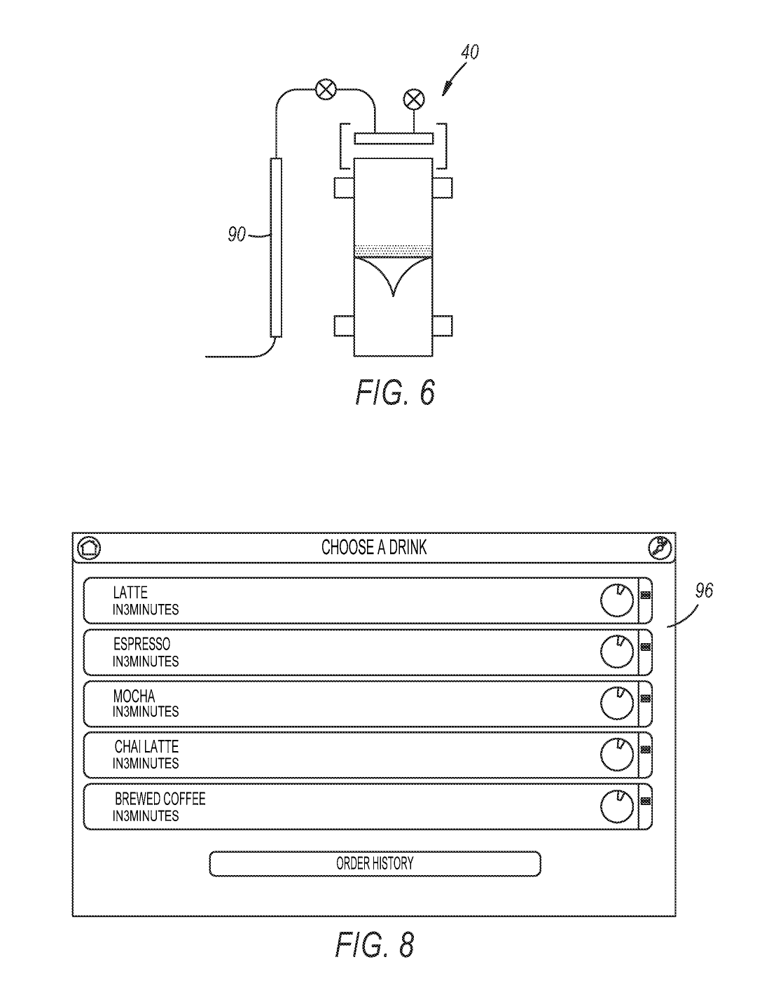

More particularly, and as shown in the embodiment illustrated in FIG. 3, the espresso unit 40 may take water as an input and use it to brew abase coffee product 78, which, in some embodiments, may be immediately dispensed into a container in which the beverage is being generated (e.g., a cup or a mixing chamber) or may be stored in a storage receptacle for later use. The water may be supplied directly from a city water supply, or it may be stored in a storage tank that is located within the kiosk 12 such that gravity provides the flow of water to the espresso unit 40. In either instance, the espresso unit 40 may include a water heater, for example, an in-line water heater designated by reference numeral 90 in FIG. 6, which depicts a portion of an illustrative embodiment of the espresso unit 40 along with a precision heater or another suitable heating device. In that regard, the espresso unit 40 may include an open or closed-loop heating system that monitors and, if necessary, adjusts the temperature of the water used by the espresso unit in the generation of a particular beverage (e.g., to meet a desired serving temperature such that water used by the espresso unit may be at a particular temperature (or within a particular temperature range) when used). In another embodiment, rather than heating the water, the espresso unit 40 may include a heating system for heating/cooling the base coffee product after it has been brewed. In either instance, it will be appreciated that the espresso unit 40 may include a temperature sensor to detect the temperature of the coffee or water. The heating system may then be controlled to adjust the temperature as necessary.

In an embodiment wherein a mixing chamber is utilized, the mixing chamber 82 may receive the base coffee product 78 as an input and may then allow for the customization the beverage, such as by adding sweeteners, diary (e.g., cold or steamed/frothed milk), water, flavored syrups, or other ingredients (i.e., additives), per the customer/user's or recipe's specification. In the illustrated embodiment, the cup handler 44 and the lid dispenser 46, which may be combined as a single component, may receive the customized coffee product 84 as an input and may package it (in some cases along with ice 88) as a final product in a cup with a lid (shown as 92 in FIG. 3). As illustrated in this example, the final product 92 may be stored in a staging area 94 prior to being presented to a customer at a presenter 48 (which may comprise one of several presenters 48 of the kiosk 12). In other embodiments, partially completed beverages and/or components thereof (e.g., base coffee or various combinations of ingredients) may be temporarily stored in a work-in-progress (WIP) staging area, which may comprise the same staging area in which completed beverages are stored (i.e., staging area 94), or a separate and distinct staging area.

As described in U.S. Pat. No. 8,515,574, the entire disclosure of which was incorporated by reference above, in various embodiments, one or more processes performed in the production of a beverage or a component thereof, such as, for example, the extraction/expression process, frothing process, etc., may be adaptively adjusted or otherwise controlled by one or a combination of components of system 10. Such processes may be adapted or controlled to take into account or compensate for various parameters or factors (e.g., environmental and/or operational parameters) relating to the production process or other conditions or characteristics relating to the particular beverage being produced (e.g., specified serving temperature of the beverage). The ability to adaptively adjust or control such processes before or during the production of the beverage may provide some assurance that those processes are being optimally and efficiently performed, and that the quality of the end product is likewise optimized.

In certain embodiments, various process profiles or metrics may be used to determine whether an adjustment to a particular process, or an operational parameter or characteristic thereof, in particular, should be made. More particularly, for any given process performed in the production of a beverage, one or more empirically-derived process profiles or other metrics (e.g., data structures) that take into account one or more parameters (e.g., operational or environmental parameters), conditions (e.g., customer preferences, type or condition of equipment used) and/or characteristics (e.g., type and/or age of coffee beans from which grounds were produced, length of time since the beans were roasted and/or ground, etc.) relating to the beverage and/or the production process corresponding thereto, may be used to evaluate the performance of the given process. In at least certain instances, the same or other process profiles or other metrics may allow for a determination to be made as to whether some action relating thereto is required or necessary, and further, what that action comprises. For example, if it is determined that some operational parameter of a given process has deviated (or, in an exemplary embodiment, unacceptably deviated) from a particular target, remedial action may be taken with respect to that process in order to correct the deviation. In certain embodiments, the beverage or the particular component (e.g., ingredient) thereof being prepared when the deviation is detected may be also discarded or wasted rather than being provided to the customer or used as an ingredient in the beverage.

It will be appreciated that with respect to system 10, in an embodiment, the functionality described above relating to the adaptability and profiling of various processes performed in the generation of a beverage may be performed in whole or in part by one or combination of the ECU 18, another component of the kiosk 12 and/or the central host 14. Accordingly, the present disclosure is not intended to be limited to any one scheme or arrangement.

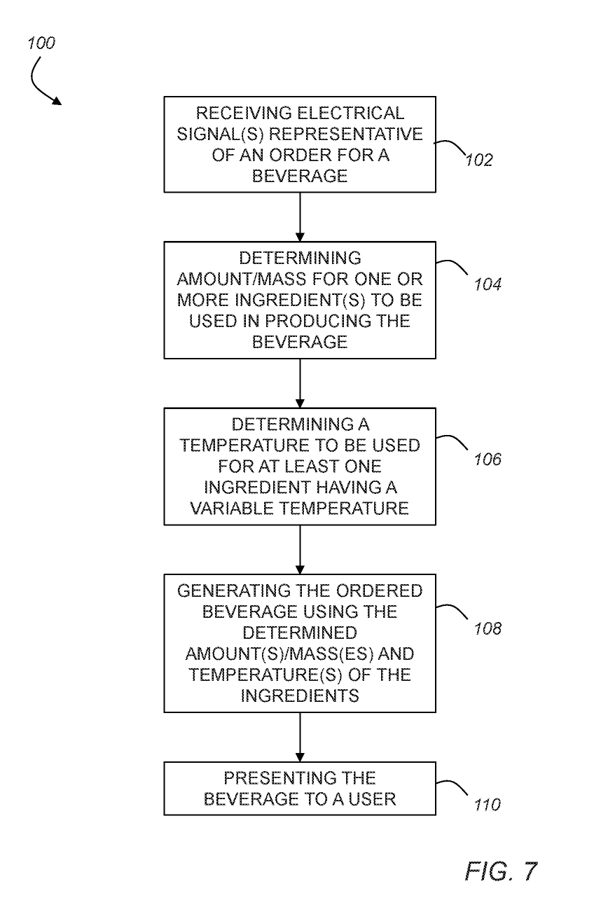

With reference to FIG. 7, there is shown a method 100 of operating an automated beverage generating system. More particularly, method 100 comprises a method for dialing in the temperature of a beverage being (or to be) generated to a specified temperature, which may be a standard or default value defined by a recipe or a value specified by a customer/user for whom the beverage is being prepared. The method 100 is intended to account for various conditions or factors relating to the generation or production of a beverage and/or attributes of the beverage itself that may have an impact on the ultimate serving temperature of the beverage.

For purposes of illustration and clarity, method 100 will be described only in the context of the automated beverage generating system 10 described above, and the kiosk 12 thereof, in particular. It will be appreciated, however, that the application of the present methodology is not meant to be limited solely to such an implementation, but rather method 100 may find application with any number of types or implementations of automated beverage generating systems. It will be further appreciated that while the steps of method 100 will be described as being performed or carried out by one or more particular components of the system 10 (e.g., the ECU 18 of the kiosk 12), in other embodiments, some or all of the steps may be performed by components of the system 10/kiosk 12 other than that or those described. Accordingly, it will be appreciated that the present disclosure is not intended to be limited to an embodiment wherein particular components are configured to perform any particular steps. Additionally, it will be appreciated that unless otherwise noted, the performance of method 100 is not meant to be limited to any one particular order or sequence of steps; rather the steps may be performed in any suitable and appropriate order or sequence and/or at the same time.

In an embodiment, method 100 includes a first step 102 of receiving one or more electrical signals representative of an order for a beverage, wherein the beverage has a specified temperature associated therewith and includes two or more ingredients, for example, a first ingredient and a second ingredient. In an embodiment, the electrical signals received in step 102, which may be received by the ECU 18 of the kiosk 12, may be generated in response to a user input that may be provided in a number of ways including, but certainly not limited to, those described below.

One way a user input may be provided is by placing an order for the beverage locally at the kiosk 12. This may be done using one or more of the interfaces 16 (e.g., the touch screen 54 illustrated in FIG. 5) that is configured to display one or more user-inputtable or user-selectable fields or links thereon to facilitate the ordering process. In such an embodiment, the ECU 18 may be configured to control the user interface(s) 16 to display such fields or links. A user may then interact with the appropriate user interface(s) 16 to place an order for, and if applicable, customize, a beverage. Another way an order may be placed locally at the kiosk 12 is by using one or more of the user interface(s) 22 that are not part of the kiosk 12, per se. More particularly, in an embodiment wherein a user input device such as, for example, a smart phone, personal computer, etc., and a component of the kiosk 12, for example, the ECU 18, are both connected to a local network (e.g., Wi-Fi, Bluetooth, etc.), a user interface 22 in the form of one or more graphical or text-based interfaces generated by, for example, application software stored on the user device, may be displayed and used to facilitate the ordering process.

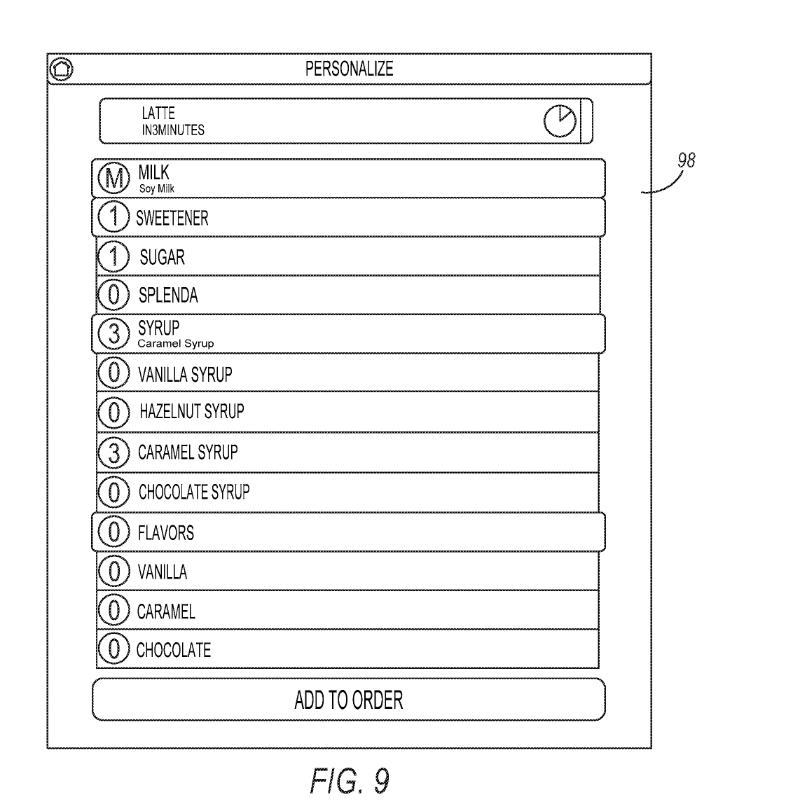

Regardless of how an order is placed locally at the kiosk 12, the ordering process is generally the same. For example, FIG. 8 depicts as representation of a graphic user interface (GUI) 96 that may be used to select a desired beverage or beverage type from one or more beverage options. The user may interact with the GUI 96 to select a particular beverage. In certain embodiments, once a particular beverage has been selected, the user may be prompted and/or permitted to customize or modify the ordered beverage. This may be accomplished using another GUI such as, for example, GUI illustrated in FIG. 9. As shown in the illustrated embodiment depicted in FIG. 9, GUI 98 may present the user with a number of selectable customization options including, for example, various additives or ingredients that may be used in the production of the beverage from which the user may make one or more selections. The GUI 98 may also permit the user to select or specify the amount or mass of each ingredient to be used, as well as to select or specify other parameters relating to the beverage such as, for example, a temperature a particular value or a range of values) at which the customer/user would like the beverage when it is ultimately presented or retrieved, and/or a time at which the beverage will be retrieved at the kiosk 12 or another kiosk of the system 10.

Whether or not the beverage being ordered is customized, once the user has completed the order, it may be sent directly or indirectly to the ECU 18 which may then either immediately initiate production of the beverage (e.g., by controlling the operation of one or more process modules 20) or, as described in greater detail in U.S. Patent Publication No. 2013/0087050 incorporated by reference above, may cause the order to be entered into a production queue resulting in the production of the beverage being delayed until a particular time in the future.

Another way a user may provide the input is by placing an order for the beverage through the central host 14 when the user is located remotely from the kiosk 12 and outside of the range of a local network corresponding thereto. More particularly, the user may interact with the central host 14 using one or more user interfaces 22 in the form of one or more GUIs or text-based interfaces generated by, for example, application software stored on a user input device, for example, a personal computer, a smart phone or another suitable device. The one or more user interface(s) 22 may then be used by the user to make various selections relating to the beverage being ordered in the same manner as that described above. In certain embodiments, the user may also be permitted to make additional selections relating to, for example, a particular kiosk and/or time at which the user would like to retrieve the beverage.

In any event, once the user has completed the ordering process in at least some embodiments and/or in at least some instances, the order may be communicated to the central host 14. The central host 14 may then relay the order to the appropriate kiosk at which the beverage will be retrieved along with, in some embodiments, specific information relating to the order (e.g., recipes to be used, time at which to commence production, customer identifying information, etc.).

It will be appreciated that while certain functionality relating to the placement of orders through one or more user interfaces has been described above, the present disclosure is not intended to be limited to such functionality and/or the particular implementations thereof. Rather, in some embodiments, additional functionality and/or alternate implementations of the functionality described above may be included.

In any event, following the receipt of an order in step 102, method 100 may move to a step 104 of determining an amount or mass of one or more—and in an embodiment, each ingredient(s) to be used in the generating or production of the ordered beverage. In an embodiment, this determination is made by the ECU 18 of the kiosk 12 and may be made in any number of ways including, but not limited to, those described below.

An example of one way in which the determination is made is by interpreting the signal(s) received in step 102 which may include the recipe, or at least a portion thereof, for the ordered beverage. That is, the received signals may be processed by the ECU 18 to extract or translate the recipe for the order and thus to determine the specifications for the ordered beverage, including the particular ingredients to be used and their respective amounts. Another way is by using the order received in step 102 and a data structure, for example, a look-up table that correlates certain beverages with the recipes therefor, to determine the amounts of the ingredients to be used. Accordingly, in such an embodiment, step 104 may comprise inputting or looking up the ordered beverage in an appropriately configured, pre-populated data structure to determine the amount of the various ingredients to be used in the generation/production of the ordered beverage. The data structure may be stored in an electronic memory device that is part of or accessible by the ECU 18 of the kiosk 12. While the description above is primarily with respect to step 104 comprising determining an amount for each ingredient to be used in the generation of the ordered beverage, in other embodiments, the determination of the amount(s) for one or more of the ingredients may not be made as part of step 104 but rather may be made as part of another step of method 100. For example, in one embodiment, the amount(s) of one or more ingredients may be determined in step 104, and the amount(s) of one or more other ingredients may be determined in another step.

Regardless of the specific way in which amounts of ingredient(s) is/are determined in step 104, step 104 may also comprise determining the temperature of one or more of the ingredients, which, for at least some of the ingredients, is a known and fixed value (e.g., a non-variable or static value) and for others may be a variable value. The temperature(s) of the ingredient(s) may be determined using data structure, for example, a look-up table, that correlates ingredients with temperatures of those ingredients to determine the temperature of one or more of the ingredients. Accordingly, in such an embodiment, step 104 may comprise inputting or looking up at least some of the ingredients in an appropriately configured, pre-populated and empirically-derived data structure to determine the temperature of that/those ingredient(s). The data structure, which may be the same data structure used to determine the amounts of the ingredients or a different data structure, may be stored in an electronic memory device that is part of or accessible by the ECU 18 of the kiosk 12. The temperature of one or more ingredients may additionally or alternatively be determined from an output of a temperature sensor in, for example, a receptacle holding the ingredient or otherwise positioned to measure the temperature of an ingredient. One or more temperature sensors configured to measure or otherwise determine the temperature of an ingredient after the ingredient has been dispensed may also be used, for example, temperature sensor(s) integrated in or associated with a load cell that holds or carries the container into which the ingredient is dispensed, temperature sensor(s) positioned to be within the flow path of the ingredient, etc.

While the determination of the temperature(s) of one or more of the ingredients was described as part of the step 104, in other embodiments, it may be its own step or part of another step of method 100. Furthermore, in at least some embodiments or implementations, step 104 may not be needed and thus may be optional. Accordingly, embodiments wherein method 100 does not include step 104 remain within the spirit and scope of the present disclosure.

In an embodiment wherein method 100 includes a step of determining the temperature of one or more ingredients as described above, method 100 may further include a step 106 of determining a temperature for at least one of the ingredients that has a variable temperature. In an embodiment, this temperature is determined to be a value that will result in the temperature of the ordered beverage being at the specified temperature when the beverage is presented to the user. For purposes of this disclosure, it will be appreciated that the temperature(s) of the ingredient(s) determined in step 106 will be such that the temperature of the ordered beverage is at the specified temperature exactly, or at least at a temperature that is within a certain predefined tolerance that will still be considered acceptable by a user and in some instances, an undetectable or unnoticeable variation from the specified temperature. In one embodiment, this tolerance may be, for example and without limitation, within 0-35 degrees Fahrenheit of the specified temperature. In another embodiment, the tolerance may be 20-30 degrees Fahrenheit; and in another embodiment the tolerance may 10-15 degrees Fahrenheit. In any event, the determination made in step 106 may be made in a number of ways and may take into account a number of factors.

For example, the determination made in step 106 may take into account the amount or mass of each ingredient to be used in generating/producing the beverage, the temperatures of the ingredients other than the ingredient(s) for which the temperature is being determined in step 106 and the particular specified serving temperature (e.g., value or range) associated with the ordered beverage. In such an embodiment, this information may be used with a data structure, for example, a look-up table, that correlates the relevant information with temperatures that should be used for one or more ingredients in order to determine the temperature for the appropriate ingredient(s). Accordingly, step 106 may comprise inputting or looking up the information described above in an appropriately configured, pre-populated and empirically-derived data structure to determine the temperature for that/those ingredient(s) for which a temperature is being determined in step 106.

In other embodiments, one or more linear or non-linear equations or formulae that take into account the amount/mass of each ingredient, the temperature(s) of the ingredients other than that for which a temperature is being determined in step 106 and the ultimate amount/mass and specified temperature of the ordered beverage may be used to determine the temperature(s) in step 106. For example, assuming the specific heat parameter for the various ingredients of a beverage are approximately uniform, a temperature for a given ingredient (i.e., ingredient “ING1”) may be determined using an equation such as, for example, equation (1):

$${T}_{ING 1} = \frac{{M}_{F} {T}_{F} - ( {M}_{ING 2} {T}_{ING 2} + … + {M}_{INGN} {T}_{INGN} )}{{M}_{ING 1}} ; \qquad ( 1 )$$

where T_{ING1} and M_{ING1} are the temperature and mass, respectively, of the ingredient being solved for step 106, M_{F} and T_{F} are the mass and temperature of the ordered beverage (i.e., a specified size and temperature of the ordered beverage) that are multiplied together, M_{ING2} and T_{ING2} are the mass and temperature of another ingredient determined in, for example, step 104, that are multiplied together, and M_{INGN} and T_{INGN} represent the mass and temperature of an additional ingredient that is included in the ordered beverage (if applicable) the product of which is summed with the products of the mass and temperature of the other ingredients.

It will be appreciated that while particular examples have been provided for determining the temperature of an ingredient based on the mass and temperatures of other ingredients used in generating an ordered beverage, the present disclosure is not intended to be limited solely to those particular examples. Rather, any suitable way for determining the temperature of an ingredient may be used in addition to or in lieu of those described above. For example, more complex linear or non-linear equations that take into account various additional parameters (e.g., specific heat of an ingredient, which one of ordinary skill in the art will understand to be the amount of heat per unit mass required to raise the temperature by one degree Celsius) and/or empirical data in data structure (e.g., look-up tables) that take into account the various parameters and as such are accounted for in the entries of the data structure. The determination can be done using one or more formulae and/or data structures.

While the description above is with respect to using the mass and temperature of the ingredients of an ordered beverage to determine the temperature to be used for one or more ingredients, in other embodiments, other factors relating to the beverage and/or the production process (e.g., volume, viscosity, specific heat, heat loss/change in the delivery mechanisms, time in/at the kiosk, etc.) may be additionally or alternatively taken into account, and thus, the present disclosure is not intended to be limited to the use of any particular factor(s). For example, the formula or a data structure can take into account instantaneous and/or historical data related to the delivery mechanism effect on the temperature of the ingredient being dispensed. For example, the tubing that delivers an ingredient could have a temperature sensor that feeds its data back to the ECU 18. The ECU 18 may then use that data to effect the determination of the temperature at which to deliver one or more of the ingredients. In an alternative embodiment, the time a delivery mechanism is idle is used to in the determination. Such data can be stored in a data structure that the ECU uses for the determination. In yet another embodiment, the affect of traffic (e.g. high usage of the tube for the delivery of multiple beverages) on the temperature is taken into consideration by the ECU to effect the determination of the temperature of one or more ingredients (e.g. high usage of the tube to deliver hot water would reduce the heat loss the next delivery of hot water experiences).

For example, in an embodiment, step 106 may take into account the length of time that is expected between the completion of the production of the ordered beverage and the presentation of the beverage to the user (e.g., the amount of time that the completed beverage will be stored in the kiosk (e.g., in the staging area 94) before it is presented to the customer/user). More specifically, based on, for example, the known traffic/load the kiosk 12 is under or experiencing (e.g., the number of beverages in the queue for the kiosk, or the number of drinks currently in process), various operating parameters of the kiosk 12 (e.g., the number and operational status of a particular type of process module) and/or the specified time at which the beverage is to be presented to the user/customer, it can be determined at least approximately how much time will elapse between the completion of the beverage and the presentation of the beverage. That length of time may be used along with, for example, a cooling profile or data structure for the kiosk 12 or at least a certain location thereof (e.g., the staging area 94, WIP area, etc.) to determine the relative amount by which the temperature of the beverage would decrease or change if that amount of time elapsed. That temperature change value may then be used to determine the temperature of one or more ingredients in step 106 that will compensate for that expected temperature reduction. In other words, if it is determined that the temperature of the beverage will be reduced by X degrees Fahrenheit, a standard or default temperature of an ingredient may be increased by at least X degrees Fahrenheit to account for the cooling effect. In an embodiment, the temperature of the ingredient may be increased by the same amount as the temperature change determined from the cooling profile; while in other embodiments, the temperature change may be used with an empirically-derived data structure to determine the temperature to be used for one or more ingredients.

In the embodiment described above, the cooling profile may be dependent upon environmental parameters such as the real-time or ambient temperature in the kiosk 12 (or at least in a particular location of the kiosk 12), which may be determined from a temperature sensor disposed within the housing of the kiosk and electrically connected to, for example, the ECU 18 of the kiosk either through a hardwired connection (e.g., via the interconnect 52 or dedicated wire(s)) or wirelessly. More specifically, in an embodiment, the cooling profile may be dependent upon the real-time temperature when the beverage is to be completed or in conjunction with a prediction of the temperature when the beverage is to be retrieved or a combination of both with a time dependency.

While a particular way of using an expected length of time between the completion of the generation of a beverage and the presentation of the beverage to a user to determine a temperature to use for a particular ingredient has been provided above, it will be appreciated that the present disclosure is not intended to be limited to any particular way of doing so; rather any suitable way may be utilized in addition to or in lieu of that described above.

Another factor that may be taken into account is an expected length of time that the beverage may be stored in at a particular location within the kiosk during the production process (i.e., between tasks performed as part of the production process and before the production process is complete). For example, one factor may be the amount of time that the incomplete beverage will be stored in the WIP area of the kiosk 12 between steps/tasks to be performed as part of the production process. More specifically, based on, for example, the known traffic/load the kiosk 12 is currently under or experiencing (e.g., the number of beverages in the queue for the kiosk, or the number of drinks currently in process), various operating parameters of the kiosk 12 (e.g., the number and operational status of a particular type of process module) and/or the specified time at which the beverage is to be presented to the user, it can be determined when and where during the process the beverage will be stored or held and for how long. That length of time may be used along with, for example, a cooling profile or data structure for the kiosk 12 or at least a certain location thereof (e.g., the WIP area, etc.) to determine the relative amount by which the temperature of the beverage would decrease or change if that amount of time elapsed. That temperature change value may then be used in the same or similar manner as that described above, which will not be repeated but rather is incorporated here by reference, to determine the temperature of one or more ingredients in step 106 that will compensate for that expected temperature reduction.

Yet another factor that may be taken into account is a length of time that is expected between when an ingredient for which a temperature is being determined in step 106 is dispensed into a container in which the beverage is being generated and when the beverage is presented to the user. More specifically, and as with other of the factors described above, based on, for example, the known traffic/load the kiosk 12 is under or experiencing (e.g., the number of beverages in the queue for the kiosk, or the number of drinks currently in process), various operating parameters of the kiosk 12 (e.g., the number and operational status of a particular type of process module) and/or the specified time at which the beverage is to be presented to the user, it can be determined at least approximately how much time will elapse between the dispensing of the ingredient and the presentation of the beverage. That length of time may be used along with, for example, a cooling profile or data structure for the kiosk 12 or at least one or more particular locations thereof (e.g., locations of certain process modules) to determine the relative amount by which the temperature of the beverage would decrease or change if that amount of time elapsed. That temperature change value may then be used in the same or similar manner as that described above, which will not be repeated but rather is incorporated here by reference, to determine the temperature of one or more ingredients in step 106 that will compensate for that expected temperature reduction.

It will be appreciated that while certain factors that may be taken into account in step 106 to determine the temperature to be used for one or more ingredients are specifically identified and described above, the present disclosure is not intended to be limited to those factors; rather, other suitable factors may certainly be used in addition or alternatively. Additionally, in an embodiment, step 106 may be performed in whole or in part by the ECU 18 of the kiosk 12 or some or all of the functionality of step 106 may be performed by one or more additional or other components of the kiosk 12 or the system 10.

Following step 106, method 100 may include a step 108 of generating the ordered beverage using the amounts of the ingredients determined in step 104 and the temperature(s) of the ingredient(s) determined in step 106. In an embodiment, this may comprise the ECU 18 controlling or commanding one or more process modules 20 or other components of the kiosk 12 to perform tasks required to generate the beverage. These tasks may include, for example and without limitation, the generation of ingredients (e.g., brewing coffee product, frothing milk, etc.) and/or the dispensing of ingredients into a container (e.g., cup or mixing chamber) in which at least a portion of the ordered beverage is being or is to be) generated. Another task may comprise heating (or cooling) one or more of the ingredients. This may include heating the ingredient(s) or components of the ingredients (e.g., water, milk, etc.) to be used in generating the ingredients to the temperature(s) determined in step 106. In an embodiment this may be accomplished by the ECU 18 (or another suitable component) controlling the operation of one or more heating mechanisms or elements (e.g., the heating system 90 of an expressor unit 40, a microwave, a heating blanket, etc. disposed within the kiosk 12). Ingredients may also be heated by controlling the operation of a process module, for example, a frothing module 42, as is known in the art (e.g., adjusting the temperature of the steam used, the depth of a wand being used, etc.). In an embodiment, step 108 may further include obtaining a cup in which to serve the ordered beverage which, depending on the particular implementation of the kiosk 12, may be performed as the first step or one of the last steps of the production process, and lidding the beverage.

In an embodiment, the generating step is performed following steps 104 and 106. It should be understood, however, that in other embodiments, one or both of steps 104 (if applicable) and 106 may be performed during the generation of the beverage. For example, an amount of a first ingredient may be determined in step 104 and then dispensed. Step 106 may then be performed to determine a temperature to be used for a second ingredient, and then that second ingredient may be dispensed at the temperature determined in step 106. In such an embodiment step 106 may actually be part of or performed during step 108.

Similarly, in an embodiment, one factor (amongst potentially others, for example, one or more of those described above) that may be taken into account in step 106 is an amount of time that has elapsed since one or more ingredient(s) was/were dispensed in step 108. In such an embodiment, step 108 may comprise a first substep of dispensing one or more ingredients required for the ordered beverage into a container in which at least a portion of the ordered beverage is being generated. As described elsewhere above, this may comprise, for example, the ECU 18 of the kiosk 12 controlling or commanding one or more process modules 20 or other components of the kiosk to dispense one or more ingredients, and in some embodiments, to generate and then dispense one or more ingredients. Step 108 may then comprise a second substep of dispensing at least one additional ingredient into the container in which at least a portion of the ordered beverage is being produced or generated wherein the ingredient has a particular temperature associated therewith.

Prior to the ingredient(s) being dispensed in the second substep, method 100 (e.g., step 106 or 108) may comprise determining an amount of time that has elapsed since the ingredient(s) was/were dispensed in the first substep. This may comprise, for example, the ECU 18 or another component of the kiosk 12 or system 10 starting a tinier or counter that is part of or separate from but electrically connected to the ECU 18 when the dispensing of the ingredient(s) in the first substep commences (e.g., when a valve is opened) or alternatively when the dispensing ceases (e.g., when a valve is closed). At the time in the production process when the second substep is to be performed, the ECU 18 may then reference the time/counter to determine the amount of time that has elapsed. That length of time may then be used in step 106 to determine the temperature(s) to be used for the ingredient(s) to be dispensed in the second substep of generating step 108. For example, the length of time may be used along with a cooling profile or other data structure for the kiosk 12, or at least one or more particular locations thereof (e.g., locations of certain process modules, staging areas (e.g., WIP area), to determine at least an approximate amount by which the temperature of the ingredient(s) dispensed in the first substep of step 108 will have changed since being dispensed. That temperature change value may then be used in the same or similar manner as that described elsewhere above to determine the temperature(s) of the ingredient(s) to be dispensed in the second substep that will compensate for the temperature change in the ingredient(s) dispensed in the first substep. The ECU 18 may then control one or more heating mechanisms or elements of the kiosk 12 so that the ingredient(s) to be dispensed reach the temperature determined in step 106 prior to being dispensed or during the dispensing of the ingredient(s).

Accordingly, in view of the foregoing, it is once again noted that the present disclosure is not intended to be limited to the steps of method 100 being performed in any particular order or sequence.

Once the ordered beverage has been generated, method 100 may proceed to a step 110 of presenting the generated beverage to a user. As described elsewhere above, this may comprise, for example, the ECU 18 commanding or controlling the cup handler 44 to move the container/cup in which the beverage is disposed to the presenter 48 where the user may retrieve it.

It will be appreciated that in at least some embodiments, method 100 may be performed without having to heat or re-heat the beverage following the production process but prior to presentation to the user (e.g., while the beverage is in a staging area such as the staging area 94). In other embodiments, however, method 100 may further comprise heating the beverage post-production in, for example, a staging area (e.g., the staging area 94).

Another aspect of the present disclosure relates to determining which component(s) of the kiosk 12 to use in performing one or more steps or tasks (hereinafter “tasks”) for producing an ordered beverage. More particularly, as described above, the kiosk 12 may include one or more beverage production stations 43 each of which is configured to perform one or more beverage production processes or tasks. In an instance wherein two or more stations 43 are at least nominally configured to perform one or more common tasks of the production process for an ordered beverage, a determination must be made as to which station(s) to use in the performance of that or those common tasks.

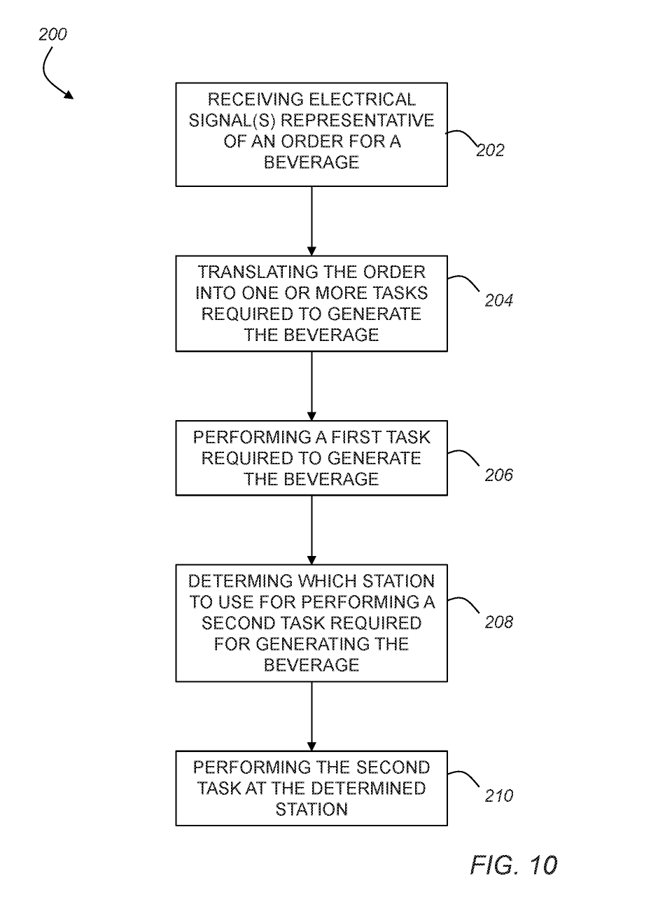

With reference to FIG. 10, a method 200 of operating an automated beverage system is illustrated, and more particularly, a method of determining which component(s) of the system (e.g., which component(s) within a kiosk of the system) to use in the performance of two or more steps or tasks of a production process for an ordered beverage.

For purposes of illustration and clarity, method 200 will be described only in the context of the automated beverage generating system 10 described above, and the kiosk 12 thereof, in particular. It will be appreciated, however, that the application of the present methodology is not meant to be limited solely to such an implementation, but rather method 200 may find application with any number of types or implementations of automated beverage generating systems. It will be further appreciated that while the steps of method 200 will be described as being performed or carried out by one or more particular components of the system 10 (e.g., the ECU 18 of the kiosk 12), in other embodiments, some or all of the steps may be performed by components of the system 10/kiosk 12 other than that or those described. Accordingly, it will be appreciated that the present disclosure is not intended to be limited to an embodiment wherein particular components are configured to perform any particular tasks. Additionally, unless otherwise noted, the performance of method 200 is not meant to be limited to any one particular order or sequence of steps; rather the steps may be performed in any suitable and appropriate order or sequence and/or at the same time.

Method 200 includes a first step 202 of receiving one or more electrical signals representative of an order for a particular beverage. In an embodiment, step 202 may be performed in the same or similar manner as that described above with respect to step 102 of method 100. As such, this description will not be repeated, but rather is incorporated here by reference.

Following step 202, method 200 may comprise a step 204 of translating the order into one or more tasks required to generate the beverage. This may be performed in the same or similar manner as that described in U.S. Patent Publication No. 2014/0277703, the entire contents of which were incorporated by reference above. To summarize, however, the order received in step 202 may be used with a data structure, for example, a look-up table, that correlates different beverages with tasks required to generate those beverages in order to determine the tasks required for the ordered beverage. In such an embodiment, the data structure may be stored in or on a memory device of the system 10, for example, a memory device of or accessible by the ECU 18 of the kiosk 12 or central host 14. It will be appreciated that step 204 may certainly be performed in any number of other suitable ways, and therefore, the present disclosure is not intended to be limited to any particular way(s) of doing so.

Once it is determined what tasks are required for the ordered beverage, method 200 comprises a step 206 of performing a first one of those tasks. Step 206 may comprise one or more substeps. For example, in at least some embodiments wherein the kiosk 12 includes a plurality of stations 43 configured to perform the first task, step 206 comprises a substep of determining which of those stations 43 to use. This determination may be made by the ECU 18 and may be based on various types of information. This information may include, for example and without limitation, the operational status of the station 43 or a component/module thereof (e.g., is it operational to perform the task or is it inoperable). The information may also include the pipelining and traffic engineering of the stations configured to perform the task and/or the optimization of the utilization of the stations or the components/modules thereof. The information may additionally or alternatively include the relative timing of when other tasks required to generate the ordered beverage are to be performed. In an embodiment, logic or software in the ECU 18 may use a rules engine to determine the most optimal station at which to perform the first task given factors/information such as one or more of those mentioned above. For example, the determination may take into account whether a given station 43 or component thereof has a disproportionate loading given the number of beverages being produced or in a queue to be produced. For instance, if many beverages requiring a frothing process are ordered and a frothing unit of a particular station is disabled or rendered inoperable, then the slack time (i.e., the time a beverage remains at a station after a process performed prior to the frothing process is complete) can be minimized by moving the container to a different station that is configured to perform the frothing process.

In certain embodiments, step 206 may also include a substep of moving or controlling the movement of a container (e.g., cup) in which at least a portion of the ordered beverage is being (or is to be) generated to the station 43 at which the first task may be performed. In an embodiment, this may comprise the ECU 18 of the kiosk 12 controlling or commanding the movement of the cup handler 44 to obtain the container and/or move the container to the appropriate station. Depending on the particular implementation, the cup handler 44 may drop the container off at the first station (i.e., place it in a designated position at or within the station (e.g., on a load cell)), or may move the container to a designated position and hold it there until it is determined that the container is to be moved elsewhere (e.g., to another station 43, to a holding area within the kiosk 12, to the presenter 48, etc.).

Whether or not step 206 includes one or more of the substeps described above, step 206 comprises the ECU 18 or another suitable component (e.g., an ECU of the station 43) controlling or commanding one or more components of the station to perform the first task, which may include: dispensing one or more ingredients into the container in which at least a portion of the ordered beverage is being generated; froth ingredient(s) previously dispensed into the container; heat ingredient(s) previously dispensed into the container; etc. In an embodiment such as that illustrated in FIG. 4 or FIG. 11 wherein an ingredient is dispensed that is routed to the station 43 from another location in the kiosk 12 (e.g., another station 43), the ECU 18 or another suitable component may control a valve that controls the flow of the ingredient to the station 43. Examples of suitable valves can be found in U.S. Patent Publication No. 2013/0087050, the entire contents of which were incorporated by reference above.

Method 200 also includes a step 208 of determining which station 43 to use for performing a second one of the tasks required to generate the ordered beverage. This determination, which may be made by the ECU 18, may based on various information such as, for example: the operational status of the stations 43 or components/modules thereof that are configured to perform the second task (e.g., whether or not the stations or components thereof are operational to perform the task); the pipelining and traffic engineering of the various stations configured to perform the task; the optimization of the utilization of the stations 43 or components/modules thereof; and/or the relative timing of when other tasks required to generate the ordered beverage are to be performed, to cite a few examples. In an instance wherein the station 43 used to perform the first task in step 206 is also configured to perform the second task, step 208 may comprise determining whether to perform the second task at that station or a different station. Determining to perform the second task at the same station at which the first task was performed would eliminate the need to move the container to another station. In any event, in at least some embodiments, the determination made in step 208 may be altered or adjusted at any time before or during the production process of the ordered beverage and prior to the performance of the second task. In an embodiment, the determination step includes not varying a default for the generation of the beverage. For example, if the default (i.e., defined by the recipe) is to perform the second task at the same location as the first task, then determination in step 208 may not include varying from that default (i.e., the determination will be made to perform the second task at the same station at which the first task is to be or was performed in accordance with the default).

In an embodiment, the determination made in step 208 may be performed during or after the movement of the container in step 206 to the station at which the first task is to be performed; in other embodiments, however, step 208 may be performed following the determination in step 206 of what station to perform the first task but before the movement of the container to that station.

In any event, method 200 further comprises a step 210 of performing the second task required to generate the ordered beverage. In an instance where it is determined in step 208 that the second task is to be performed at the same station at which the first task was performed in step 206, step 210 comprises simply performing the second task. In an instance, however, where it is determined in step 208 that the second task is to be performed at a different station, step 210 would comprise a substep of moving or controlling the movement of the container from the station at which the first task was performed to the station at which the second task is to be performed, which was determined in step 208. In an embodiment, this may comprise the ECU 18 of the kiosk 12 controlling or commanding the movement of the cup handler 44 to obtain the container from the first station and/or to move the container to the appropriate station 43.

Regardless of where the second task is to be performed, step 210 comprises the ECU 18 or another suitable component (e.g., an of the station 43) controlling or commanding one or more components of the station at which the second task is to be performed to, for example, perform the second task, which may comprise: dispensing of one or more ingredients into the container in which at least a portion of the ordered beverage is being generated; frothing ingredient(s) previously dispensed into the container; heating ingredient(s) previously dispensed into the container; etc. In an embodiment wherein an ingredient is dispensed that is routed to the station 43 from another location in the kiosk 12 (e.g., as shown in FIG. 11)), the ECU 18 or another suitable component may control a valve that controls the flow of the ingredient to the station 43.

It will be appreciated that while the description above has been with respect to only two tasks required to be performed for the generation of an ordered beverage, method 200 may certainly be applied to beverages requiting more than two tasks. For example, in an instance wherein an ordered beverage includes a third step, the same methodology described above may be applied to determine what station to use to perform that task (e.g., the station(s) at which the first and/or second tasks were (or are to be) performed or a completely different station). Accordingly, the present disclosure is not intended to be limited to the application of method 200 to beverages having any particular number of tasks.

Additionally, while the description above has been primarily with respect to determining which station(s) at which to perform each task of a beverage production process, in other embodiments, the determination made in method 200 may be between one or more stations and one or more process modules/other components of the kiosk 12, or between two or more process modules or other components of the kiosk 12. Accordingly, the present disclosure is not intended to be limited to any particular application of method 200.

### Networking of Kiosks

As was described above, each kiosk 12 is configured to communicate with central host 14 and, in certain embodiments, one or more other kiosks 12. As was also described above, this communication may be facilitated over any number of different types of networks and using any number of different types of communication techniques/protocols, such as, for example those described above.

In an exemplary embodiment, the kiosks 12 and the central host 14 that are networked together may be used as a distributed server/computing structure in order to perform, for example, various functions, interfacing, data storage, data caching, and data retrieval. In an exemplary embodiment, this may be achieved or accomplished using various known data duplication and synchronization techniques on a central host/kiosk basis, as well as a multiple kiosk basis.

More particularly, when a new kiosk 12 is installed in system 10, a new network node (i.e., a server or computing node) is effectively created that may process orders received thereat or from the central host 14 or another kiosk 12, store data, etc. In an exemplary embodiment, each time a node or kiosk is added to system 10, a corresponding IP address is assigned to that kiosk by central host 14. The IP address may be a static IP address, or alternatively, a dynamic IP address in embodiments in which a dynamic domain name service (DNS) is utilized. Accordingly, in general terms, all that may be necessary when a new kiosk is added to the system 10 is the updating of geographically-based DNS entries to include that kiosk.

As was briefly described above, in an exemplary embodiment wherein the system 10 includes a plurality of kiosks 12, the individual kiosks that are networked together may be configured to communicate with each other. For example, the kiosks 12 may be configured to ping each other to determine whether there is a problem or failure with the central host 14, the network over which the kiosk communicates with central host 14 or the kiosk itself. Accordingly, if, for example, a kiosk has sent an inquiry to the central host 14 and does not receive a response either in the nature of a receipt acknowledgment or the requested information, that kiosk may then ping another kiosk to allow it to diagnose where the problem may be.

In an embodiment, the networking of two or more kiosks 12 together may also provide the ability to share information between kiosks in a similar manner to that described above with respect to the sharing of information between a kiosk and the central host 14. Accordingly, in an exemplary embodiment, each kiosk 12 may be configured to share information with one or more other kiosks that may be required for the one or more other kiosks to sufficiently operate. This information may include, for example, beverage recipes, customer-specific information (e.g., beverage preferences, order histories, loyalty program information, account information, etc.), operational parameters for different components of the kiosk, as well as any number of other types of information or data. To that end, in an embodiment, two or more kiosks 12 may be automatically synchronized with each other periodically so that some or all of the information/data stored at one kiosk is also stored at one or more other kiosks. Additionally, or alternatively, the kiosks may be synchronized each time a triggering event occurs, such as, for example, a change has been made to the relevant information/data, or upon a request to do so from one of the kiosks.

In at least some embodiments, the networking of two or more kiosks 12 together also provides the ability for a beverage ordered at one kiosk to be generated at another kiosk. That is, a first kiosk may be configured to control or command a second kiosk to generate a beverage ordered at or through the first kiosk.

In an exemplary embodiment, another feature of the system 10 relates to the ability of some or all of the components thereof to communicate with each other over multiple networks and/or using multiple communication techniques/protocols. For example, in an exemplary embodiment, one or more kiosks 12 may be configured to communicate with the host 14 and, in various embodiments, each other, over a primary network, hut may also be configured to switch or fail over to one or more secondary or back-up network(s) in the event a problem occurs with the primary or first network. For example, the kiosk(s) 12 may be configured to communicate with the central host 14 and/or each other over an internet connection, as well as over a dial-up connection, which may already be built into the system for processing credit card payments, for example. Alternatively, rather than having a primary and one or more secondary networks, the components may be configured to select a network over which to communicate based on, for example, whether one or more other networks are inactive or operating less than optimally, the particular network(s) supported by a particular component(s) with which a component wishes to communicate, etc. Accordingly, the ability to communicate over multiple networks adds one or more layers of redundancy and/or flexibility that may further optimize the operation and performance of the system 10.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of operating an automated beverage generating system, comprising:
receiving one or more electrical signals representative of an order for a beverage, wherein the beverage has a specified temperature associated therewith and includes at least a first ingredient and a second ingredient;
determining an amount of the first ingredient to be used in generating the beverage, the first ingredient having a first temperature associated therewith;
determining an amount of the second ingredient to be used in generating the beverage and determining a second temperature to be used for the second ingredient based at least in part on the amount and the first temperature of the first ingredient and the amount of the second ingredient so that the beverage will be at the specified temperature when the generation of the beverage is complete and the generated beverage is presented;
generating the beverage using the determined amount of the first ingredient and the determined amount and the determined second temperature of the second ingredient; and
presenting the generated beverage.

2. The method of claim 1, further comprising determining a length of time that is expected between the completion of the generation of the beverage and the presentation of the generated beverage, and wherein determining the second temperature to be used for the second ingredient is further based on the determined length of time.

3. The method of claim 1, wherein determining the second temperature to be used for the second ingredient is further based on an expected amount of time that the beverage will be stored at a particular location within the system prior to the presentation of the beverage.

4. The method of claim 1, wherein:
generating the beverage comprises dispensing the determined amount of the first ingredient and the determined amount of the second ingredient at the second temperature;
the method further comprises determining a length of time that is expected between the dispensing of the second ingredient and the presentation of the generated beverage to the user; and
determining the second temperature to be used for the second ingredient is further based on the determined length of time.

5. The method of claim 1, wherein the specified temperature comprises a particular temperature value.

6. The method of claim 1, wherein the specified temperature comprises a temperature range.

7. The method of claim 1, wherein generating the beverage comprises dispensing the determined amount of the first ingredient and the determined amount of the second ingredient at the second temperature, the generating step further comprising controlling a heating mechanism of the system so that the second ingredient reaches the determined temperature prior to being dispensed.

8. The method of claim 1, further comprising determining the first temperature of the first ingredient, wherein the first temperature is determined after the first ingredient is dispensed into a container in which at least a portion of the ordered beverage is being generated.

9. An automated beverage generating system, comprising:
an electronic processor having one or more electrical inputs and one or more electrical outputs; and
an electronic memory device electrically coupled to the electronic processor and having instructions stored therein,
wherein the electronic processor is configured to access the memory device and execute the instructions stored therein such that electronic processor is configured to:
receive one or more electrical signals representative of an order for a beverage, wherein the beverage has a specified temperature associated therewith and includes at least a first ingredient and a second ingredient;
determine an amount of the first ingredient to be used in generating the beverage, the first ingredient having a first temperature associated therewith;
determine an amount of the second ingredient to be used in generating the beverage and determine a second temperature to be used for the second ingredient based at least in part on the amount and the first temperature of the first ingredient and the amount of the second ingredient so that the beverage will be at the specified temperature when the generation of the beverage is complete and the beverage is presented;
command the generation of the beverage using the determined amount of the first ingredient and the determined amount of the second ingredient at the second temperature.

10. The system of claim 9, wherein the electronic processor is further configured to determine a length of time that is expected between the completion of the generation of the beverage and the presentation of the generated beverage to a user, and wherein the determination of the second temperature to be used for the second ingredient is further based on the determined length of time.

11. The system claim 8, wherein the determination of the second temperature to be used for the second ingredient is further based on an expected amount of time that the beverage will be stored at a particular location within the system prior to the presentation of the beverage to a user.

12. The system of claim 9, wherein:
commanding the generation of the beverage comprises commanding the dispensing of the determined amount of the first ingredient and the determined amount of the second ingredient at the second temperature;
the electronic processor configured to determine a length of time that is expected between the dispensing of the second ingredient and the presentation of the generated beverage to a user; and
the determination of the second temperature is further based on the determined length of time.

13. The system of claim 9, wherein the specified temperature comprises a particular temperature value or a temperature range.

14. The system of claim 9, wherein:
commanding the generation of the beverage comprises commanding the dispensing of the determined amount of the first ingredient and the determined amount of the second ingredient at the second temperature; and
the electronic processor is configured to control a heating mechanism of the system so that the second ingredient reaches the second temperature prior to being dispensed.

15. The system of claim 9, wherein the electronic processor is configured to determine the first temperature of the first ingredient, wherein the first temperature is determined after the first ingredient is dispensed into a container in which at least a portion of the ordered beverage is being generated.

16. A method of operating an automated beverage generating system, comprising:
receiving one or more electrical signals representative of an order for a beverage, wherein the beverage has a specified temperature associated therewith;
dispensing a first ingredient into a container in which at least a portion of the beverage is being generated; and
dispensing a second ingredient into the container, the second ingredient having a temperature associated therewith,
wherein prior to dispensing the second ingredient, the method comprises:
determining an amount of time that has elapsed since the first ingredient was dispensed into the container; and
determining the temperature to be used for the second ingredient based at least in part on the amount time that has elapsed so that the beverage will be at the specified temperature when the generation of the beverage is complete.

17. The method of claim 16, wherein the specified temperature comprises a particular temperature value.

18. The method of claim 16, wherein the specified temperature comprises a temperature range.

19. The method of claim 16, further comprising controlling a heating mechanism of the system so that the second ingredient reaches the determined temperature prior to being dispensed.

20. The method of claim 16, wherein the first ingredient has a first temperature associated therewith and the temperature associated with the second ingredient is a second temperature, and further wherein determining the second temperature of the second ingredient is based at least in part on the amount of time that has elapsed and the value of the first temperature.

21. The method of claim 20, further comprising determining the first temperature of the first ingredient, wherein the first temperature is determined after the first ingredient is dispensed into the container.

22. An automated beverage generating system, comprising:
an electronic processor having one or more electrical inputs and one or more electrical outputs; and
an electronic memory device electrically coupled to the electronic processor and having instructions stored therein,
wherein the electronic processor is configured to access the memory device and execute the instructions stored therein such that electronic processor is configured to:
receive one or more electrical signals representative of an order for a beverage, wherein the beverage has a specified temperature associated therewith;
command the dispensing of a first ingredient into a container in which at least a portion of the beverage is being generated; and
command the dispensing of a second ingredient into the container the second ingredient having a temperature associated therewith,
wherein prior to commanding the dispensing the second ingredient, the electronic processor is configured to:
determine an amount of time that has elapsed since the first ingredient was dispensed into the container; and
determine the temperature to be used for the second ingredient based at least in part on the amount time that has elapsed so that the beverage will be at the specified temperature when the generation of the beverage is complete.

23. The system of claim 22, wherein the specified temperature comprises a particular temperature value or a temperature range.

24. The system of claim 22, further comprising controlling a heating mechanism of the system so that the second ingredient reaches the determined temperature prior to being dispensed.

25. The system of claim 22, wherein the first ingredient has a first temperature associated therewith and the temperature associated with the second ingredient is a second temperature, and further wherein the electronic processor is configured to determine the second temperature of the second ingredient based at least in part on the amount of time that has elapsed and the value of the first temperature.

26. The method of claim 25, wherein the electronic processor is configured to determine the first temperature of the first ingredient, wherein the first temperature is determined after the first ingredient is dispensed into the container.
